(19) United States
(12) Patent Application Publication
(10) Pub. No.: US 2025/0091618 A1
(43) Pub. Date: Mar. 20, 2025

(54) INTERPRETABLE TRAJECTORY PREDICTION FOR AUTONOMOUS AND SEMI-AUTONOMOUS SYSTEMS AND APPLICATIONS

(71) Applicant: NVIDIA Corporation, Santa Clara, CA (US)

(72) Inventors: Yuxiao CHEN, Newark, CA (US); Kai-Chieh HSU, Princeton, NJ (US); Karen Yan Ming LEUNG, Seattle, WA (US); Marco PAVONE, Stanford, CA (US)

(73) Assignee: NVIDIA Corporation, Santa Clara, CA (US)

(21) Appl. No.: 18/470,942

(22) Filed: Sep. 20, 2023

(51) Int. Cl. B60W 60/00

(52) U.S. Cl. CPC B60W 60/0027; B60W 60/0015

(57) ABSTRACT

In various examples, a trajectory prediction model provides interpretable trajectory predictions for autonomous and semi-autonomous systems and applications via counterfactual game-theoretic reasoning. Model-based latent variables can be formulated through responsibility evaluations. Responsibility can be broken into multiple components, such as safety and courtesy. Responsibility can be quantified, for example, by answering a counterfactual question: could an agent have executed differently to respect other agents' safety and be more courteous to others' plans? The framework can be used to abstract computed responsibility sequences into different responsibility levels and ground latent levels into a trajectory prediction model able to render interpretable and accurate inferences about trajectory.

### BACKGROUND

Approaches to predicting behaviors of other agents (such as other vehicles in an ego vehicle's surroundings) can be categorized as one of two types: phenomenological methods and ontological methods. Phenomenological methods infer other agents' behavior through deep neural networks and a large amount of traffic data. The predicted trajectories produced by phenomenological methods, however, are not explainable, making it difficult to use them for ex-post analysis or integration into downstream tasks such as planning and control. Ontological methods build explicit models of the internal decision-making processes or interaction structures of agents. Ontological methods can offer interpretable explanations for their predictions, but they do not efficiently leverage traffic data, show poor scalability when the number of involved agents is large, cannot generalize across different traffic scenarios, and/or fail to encode a broad distribution of behaviors.

### SUMMARY

Embodiments of the present disclosure relate to interpretable trajectory prediction for autonomous and semi-autonomous systems and applications via counterfactual game-theoretic reasoning. Systems and methods are disclosed that can provide a trajectory prediction model to generate, based at least on one or more movements, a trajectory for an agent. The trajectory prediction model may employ a responsibility formulation. Responsibility can be formulated as a measure of how much an agent takes into account the welfare of other agents through counterfactual reasoning. For example, responsibility can be formulated based at least on counterfactual metrics, such as a safety metric and a courtesy metric. In contrast to conventional systems, the disclosed approach improves accuracy and interpretability of agent behavior predictions, helping reduce over-conservatism by autonomous and semi-autonomous systems in decision-making strategies and leading to more efficient and performant behaviors by autonomous and semi-autonomous systems.

At least one aspect relates to a processor (e.g., one or more processors or processing units). The processor may be, or may comprise, one or more circuits. The one or more circuits may be configured to obtain sensor data corresponding to one or more movements of a query agent proximate to an autonomous or semi-autonomous system. The one or more circuits may be configured to execute a trajectory prediction model to generate a trajectory for at least one of the query agent or the autonomous or semi-autonomous system. The trajectory may be generated at least on the one or more movements. The trajectory prediction model may comprise a responsibility formulation that is based at least on one or more counterfactual metrics.

In various embodiments, the responsibility formulation is indicative of a classification for at least one of the query agent or the autonomous or semi-autonomous system. In various embodiments, the one or more counterfactual metrics includes one or more of a safety metric and/or a courtesy metric for the query agent. In various embodiments, the one or more counterfactual metrics includes a safety metric for the query agent with respect to at least one of the autonomous or semi-autonomous system or one or more agents other than the query agent. In various embodiments, the safety metric is indicative of one or more safety margins maintained by the query agent with respect to at least one of the autonomous or semi-autonomous system or one or more agents other than the query agent. In various embodiments, the one or more counterfactual metrics includes a courtesy metric for the query agent with respect to the autonomous or semi-autonomous system. In various embodiments, the courtesy metric is indicative of an influence, on the query agent, of at least one of the autonomous or semi-autonomous system or one or more agents other than the query agent. In various embodiments, the courtesy metric is based at least on a Kullback-Leibler (KL) divergence between at least two distributions. In various embodiments, the at least two distributions correspond to motion of the query agent (1) with the autonomous or semi-autonomous system or with one or more agents other than the query agent, and (2) without the autonomous or semi-autonomous system or without the one or more agents other than the query agent. In various embodiments, the one or more counterfactual metrics includes a safety metric and/or a courtesy metric for the query agent. In various embodiments, the responsibility formulation uses a reward function. In various embodiments, the one or more circuits are configured to execute a maneuver by the autonomous or semi-autonomous system based at least on the generated trajectory.

At least one other aspect relates to a system. The system may comprise, or consist of, one or more processing units to perform operations comprising: obtaining sensor data corresponding to one or more movements of a first agent proximate to a second agent; and executing a trajectory prediction model to generate, based at least on the one or more movements, a trajectory for at least one of the first agent or the second agent. The trajectory prediction model may include a responsibility formulation that is based at least on one or more counterfactual metrics.

In various embodiments, the one or more counterfactual metrics includes a safety metric for the first agent with respect to at least one of the second agent and/or one or more agents other than the first agent. In various embodiments, the safety metric is indicative of one or more safety margins maintained by the first agent with respect to at least one of the second agent and/or one or more agents other than the first agent. In various embodiments, the one or more counterfactual metrics includes a courtesy metric for the first agent with respect to the second agent. In various embodiments, the courtesy metric is indicative of an influence, on the first agent, of at least one of the second agent and/or one or more agents other than the first agent. In various embodiments, the one or more counterfactual metrics includes a safety metric and a courtesy metric for the first agent. In various embodiments, the system is an autonomous or semi-autonomous vehicle. In various embodiments, the vehicle comprises one or more sensors from which the sensor data or a portion thereof are received. In various embodiments, the vehicle comprises a control system configured to execute, based on the generated trajectory, a second trajectory for the vehicle.

At least one other aspect relates to a method. The method may consist of, or comprise: obtaining sensor data corresponding to one or more movements of a query agent proximate to a dynamic system; and executing a trajectory prediction model to generate, based at least on the one or more movements, a trajectory for at least one of the query agent and/or the dynamic system, the trajectory prediction model comprising a responsibility formulation that is based at least on a safety metric and a courtesy metric.

In various embodiments, the processors, systems, and/or methods described herein can be implemented by or via, or can be included in, at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for performing conversational AI operations; a system implementing one or more language models; a system implementing one or more large language models (LLMs); a system for performing one or more generative AI operations; a system for generating synthetic data; a system incorporating one or more virtual machines (VMs); a system implemented at least partially in a data center; and/or a system implemented at least partially using cloud computing resources.

### BRIEF DESCRIPTION OF THE DRAWINGS

The present systems and methods for interpretable trajectory prediction for autonomous and semi-autonomous systems and applications are described in detail below with reference to the attached drawing figures, wherein:

FIG. 1A is an illustration of an example autonomous vehicle, in accordance with some embodiments of the present disclosure;

FIG. 1B is an example of camera locations and fields of view for the example autonomous vehicle of FIG. 1A, in accordance with some embodiments of the present disclosure;

FIG. 1C is a block diagram of an example system architecture for the example autonomous vehicle of FIG. 1A, in accordance with some embodiments of the present disclosure;

FIG. 1D is a system diagram for communication between cloud-based server(s) and the example autonomous vehicle of FIG. 1A, in accordance with some embodiments of the present disclosure;

FIG. 2 is a block diagram of an example computing device suitable for use in implementing some embodiments of the present disclosure; and

FIG. 3 is a block diagram of an example data center suitable for use in implementing some embodiments of the present disclosure.

FIG. 4 is an example flowchart depicting a process through which a system may employ a model to predict a trajectory, in accordance with some embodiments of the present disclosure;

FIG. 5 depicts an example interpretability framework for a wide range of phenomenological trajectory prediction methods through responsibility evaluations, in accordance with some embodiments of the present disclosure;

FIG. 6 depicts an example distribution of safety and courtesy responsibility of a training set (left) and validation set (right), in accordance with some embodiments of the present disclosure;

FIG. 7 depicts, on the left, an example Bayesian information criterion under a different number of levels, and on the right, observation distributions of a hidden Markov model (HMM) with five responsibility levels, in accordance with some embodiments of the present disclosure;

FIG. 8 shows, in the top row, that a queried agent demonstrates irresponsible behavior when it tries to overtake a target agent, while the bottom row shows that the queried agent becomes responsible after they overtake, in accordance with some embodiments of the present disclosure;

FIG. 9 illustrates that an example responsibility-dependent reward function gives diverse and interpretable trajectory prediction, in accordance with some embodiments of the present disclosure; and

FIG. 10 depicts a comparison of ground-truth trajectories and predicted trajectories, illustrating that a responsibility-aware prediction outperforms a heuristic reward-based bilevel imitation for traffic simulation (BITS) model, in accordance with some embodiments of the present disclosure.

### DETAILED DESCRIPTION

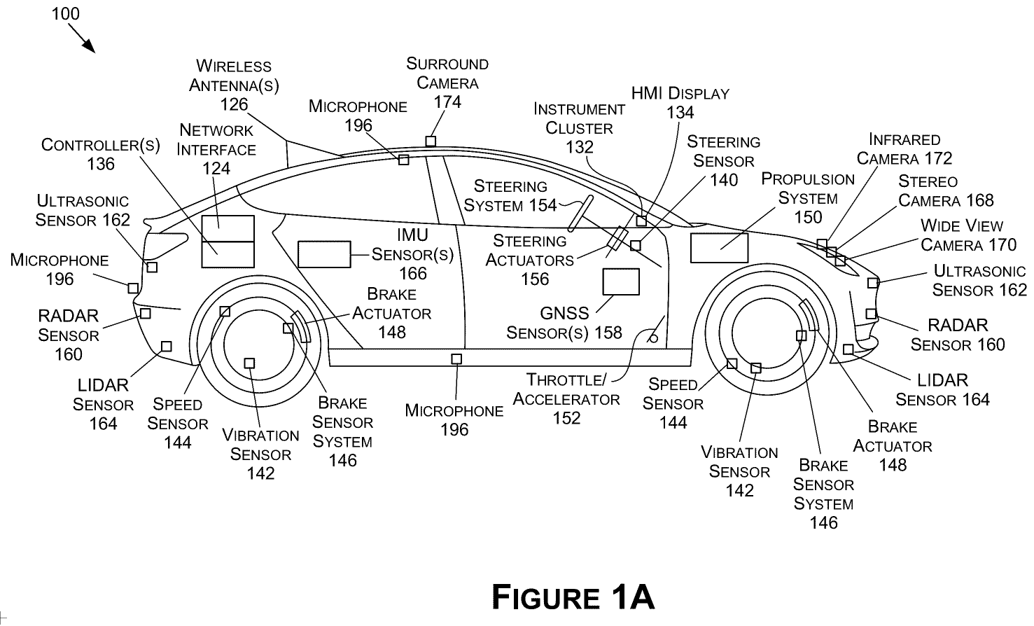

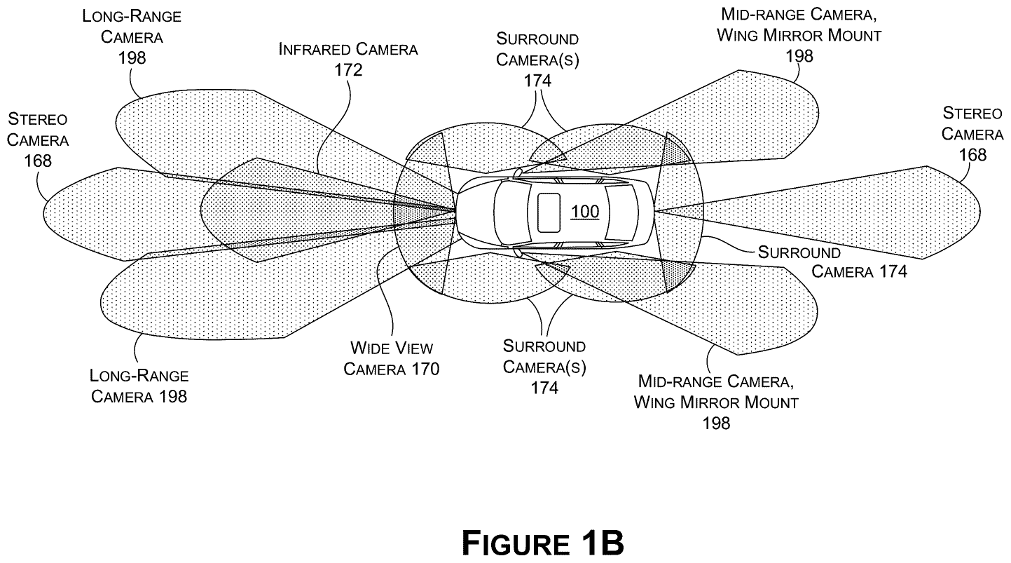

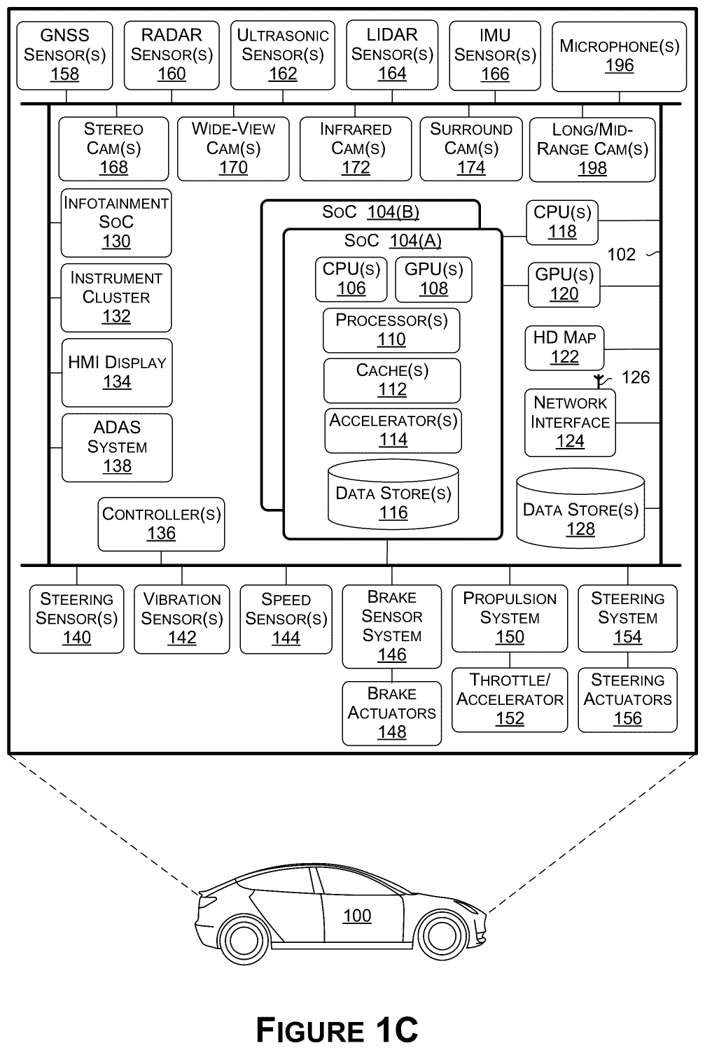

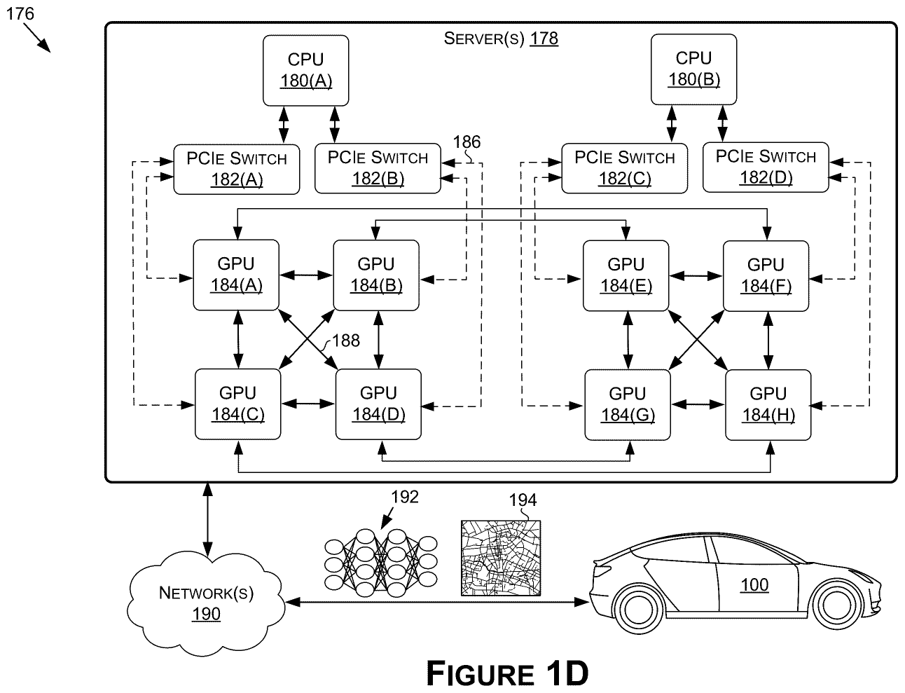

Systems and methods are disclosed related to interpretable trajectory prediction for autonomous and semi-autonomous systems and applications. Although the present disclosure may be described with respect to an example autonomous vehicle 100 (alternatively referred to herein as “vehicle 100” or “ego-machine 100,” an example of which is described with respect to FIGS. 1A-1D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to trajectory prediction for autonomous or semi-autonomous driving, this is not intended to be limiting, and the systems and methods described herein may be used in augmented reality, virtual reality, mixed reality, robotics, security and surveillance, autonomous or semi-autonomous machine applications, and/or any other technology spaces where trajectory prediction may be used.

Various autonomous and semi-autonomous systems, such as autonomous vehicles (AVs), evaluate movements of agents (e.g., vehicles) in their surroundings to make predictions about trajectories of the agents so that, for example, collisions can be avoided. One major challenge faced by AVs is planning for the future in interactive driving scenarios, since AVs need to be responsible for the safety of road users (e.g., other drivers, pedestrians, and cyclists) but simultaneously comply with the traffic law and balance the trade-off between conservatism and task performance (e.g., passenger comfort and mobility). In such interactive settings, an autonomous or semi-autonomous system may reason about other agents' uncertainty and interaction dynamics to select its control strategies and tactics (e.g., changes in direction and/or speed). However, because safety is paramount, the uncertainty and lack of transparency in the behaviors of other agents often lead to overly conservative system behaviors, which impedes performance. Improving the accuracy and interpretability of agent behavior prediction models can help achieve a level of conservatism that better achieves both safety and performance.

To combine benefits from both ontological and phenomenological methods, the disclosed approach provides an interpretable lens for a wide range of phenomenological approaches by using model-based latent variables. These latent variables can be formulated by responsibility evaluations, as responsibility is inherent in human behaviors. This is consistent with legal frameworks that seek to manage the risk of traffic accidents in part by enforcing responsibility, or duty of care, on each road user. Responsibility can be broken into multiple components, such as the following two components: (1) how much does an agent care about its margin to the collision with other agents? and (2) how much does an agent influence other agents' behaviors?

Rather than relying on a specific model of agents' decision-making, embodiments of the disclosed approach may use a phenomenological traffic model to generate counterfactual control strategies that an agent could have taken and answer the above questions to quantify the agent's responsibility. The disclosed approach can thus provide an interpretable framework for a wide range of phenomenological methods of predicting trajectories based at least in part on responsibility evaluations. This interpretable framework can abstract computed responsibility sequences into different responsibility levels and ground these latent levels into a trajectory prediction model able to render interpretable and accurate inferences. Embodiments of the disclosed responsibility-based interpretability framework can be modular and easily integrated into a wide range of prediction models.

As further discussed herein, embodiments of the disclosed approach may formulate responsibility by answering a counterfactual question: could an agent have executed differently to respect other agents' safety and be more courteous to others' plans. A hierarchical framework can be employed to categorize the intention behind interactions between agents into various levels of responsibility and link these levels to models for predicting trajectories. Simulation studies show that the disclosed responsibility metrics can be used to cluster human behaviors into different groups and are provide more interpretable and accurate trajectory predictions.

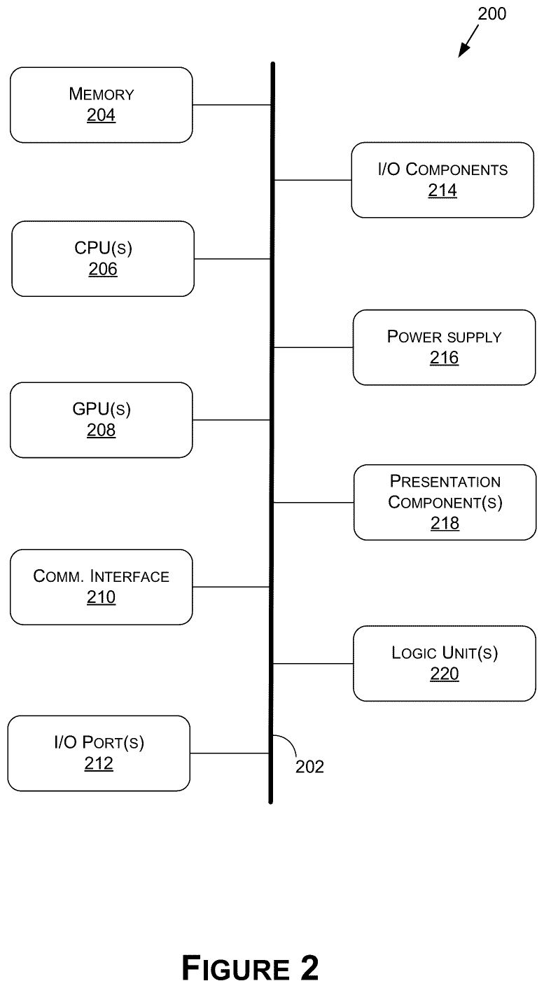

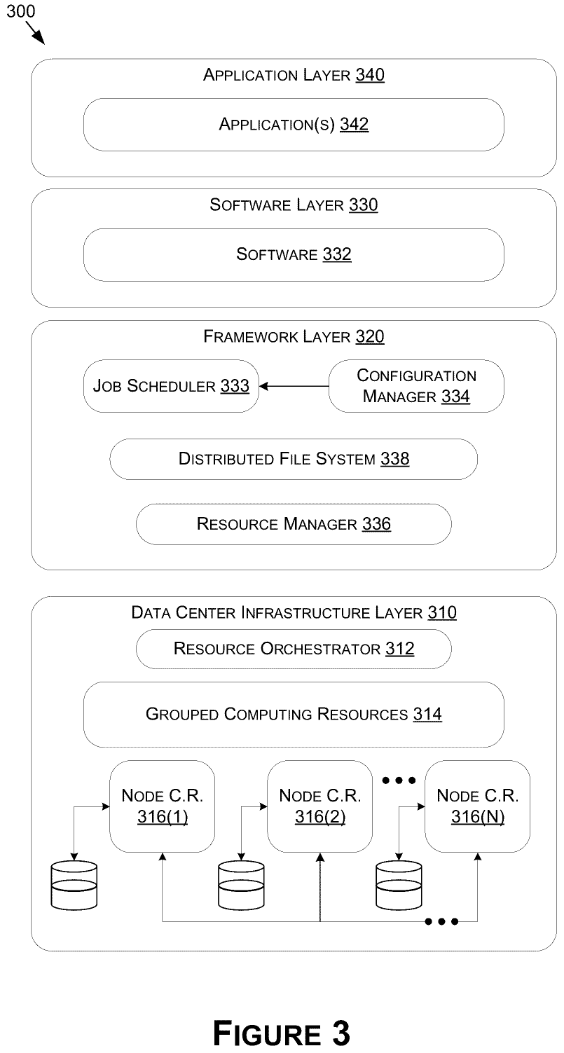

With reference to FIG. 1, FIG. 1 is an example autonomous or semi-autonomous vehicle capable of navigating based on trajectory predictions generated using trajectory prediction models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 100 of FIGS. 1A-1D, example computing device 200 of FIG. 2, and/or example data center 300 of FIG. 3.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

### Example Autonomous Vehicle

FIG. 1A is an illustration of an example autonomous vehicle 100, in accordance with some embodiments of the present disclosure. The autonomous vehicle 100 (alternatively referred to herein as the “vehicle 100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 100 may be capable of functionality in accordance with one or more of Level 3-Level 5 of the autonomous driving levels. The vehicle 100 may be capable of functionality in accordance with one or more of Level 1-Level 5 of the autonomous driving levels. For example, the vehicle 100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 100 or other machine, such as being fully autonomous, being highly autonomous, being conditionally autonomous, being partially autonomous, providing assistive autonomy, being semi-autonomous, being primarily autonomous, or other designation.

The vehicle 100 may include components such as a chassis, a vehicle body, wheels (e.g., 2, 4, 6, 8, 18, etc.), tires, axles, and other components of a vehicle. The vehicle 100 may include a propulsion system 150, such as an internal combustion engine, hybrid electric power plant, an all-electric engine, and/or another propulsion system type. The propulsion system 150 may be connected to a drive train of the vehicle 100, which may include a transmission, to enable the propulsion of the vehicle 100. The propulsion system 150 may be controlled in response to receiving signals from the throttle/accelerator 152.

A steering system 154, which may include a steering wheel, may be used to steer the vehicle 100 (e.g., along a desired path or route) when the propulsion system 150 is operating (e.g., when the vehicle is in motion). The steering system 154 may receive signals from a steering actuator 156. The steering wheel may be optional for full automation (Level 5) functionality.

The brake sensor system 146 may be used to operate the vehicle brakes in response to receiving signals from the brake actuators 148 and/or brake sensors.

Controller(s) 136, which may include one or more system on chips (SoCs) 104 (FIG. 1C) and/or GPU(s), may provide signals (e.g., representative of commands) to one or more components and/or systems of the vehicle 100. For example, the controller(s) may send signals to operate the vehicle brakes via one or more brake actuators 148, to operate the steering system 154 via one or more steering actuators 156, to operate the propulsion system 150 via one or more throttle/accelerators 152. The controller(s) 136 may include one or more onboard (e.g., integrated) computing devices (e.g., supercomputers) that process sensor signals, and output operation commands (e.g., signals representing commands) to enable autonomous driving and/or to assist a human driver in driving the vehicle 100. The controller(s) 136 may include a first controller 136 for autonomous driving functions, a second controller 136 for functional safety functions, a third controller 136 for artificial intelligence functionality (e.g., computer vision), a fourth controller 136 for infotainment functionality, a fifth controller 136 for redundancy in emergency conditions, and/or other controllers. In some examples, a single controller 136 may handle two or more of the above functionalities, two or more controllers 136 may handle a single functionality, and/or any combination thereof.

The controller(s) 136 may provide the signals for controlling one or more components and/or systems of the vehicle 100 in response to sensor data received from one or more sensors (e.g., sensor inputs). The sensor data may be received from, for example and without limitation, global navigation satellite systems (“GNSS”) sensor(s) 158 (e.g., Global Positioning System sensor(s)), RADAR sensor(s) 160, ultrasonic sensor(s) 162, LIDAR sensor(s) 164, inertial measurement unit (IMU) sensor(s) 166 (e.g., accelerometer(s), gyroscope(s), magnetic compass(es), magnetometer(s), etc.), microphone(s) 196, stereo camera(s) 168, wide-view camera(s) 170 (e.g., fisheye cameras), infrared camera(s) 172, surround camera(s) 174 (e.g., 360 degree cameras), long-range and/or mid-range camera(s) 198, speed sensor(s) 144 (e.g., for measuring the speed of the vehicle 100), vibration sensor(s) 142, steering sensor(s) 140, brake sensor(s) (e.g., as part of the brake sensor system 146), and/or other sensor types.

One or more of the controller(s) 136 may receive inputs (e.g., represented by input data) from an instrument cluster 132 of the vehicle 100 and provide outputs (e.g., represented by output data, display data, etc.) via a human-machine interface (HMI) display 134, an audible annunciator, a loudspeaker, and/or via other components of the vehicle 100. The outputs may include information such as vehicle velocity, speed, time, map data (e.g., the High Definition (“HD”) map 122 of FIG. 1C), location data (e.g., the vehicle's 100 location, such as on a map), direction, location of other vehicles (e.g., an occupancy grid), information about objects and status of objects as perceived by the controller(s) 136, etc. For example, the HMI display 134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 100 further includes a network interface 124 which may use one or more wireless antenna(s) 126 and/or modem(s) to communicate over one or more networks. For example, the network interface 124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 1B is an example of camera locations and fields of view for the example autonomous vehicle 100 of FIG. 1A, in accordance with some embodiments of the present disclosure. The cameras and respective fields of view are one example embodiment and are not intended to be limiting. For example, additional and/or alternative cameras may be included and/or the cameras may be located at different locations on the vehicle 100.

The camera types for the cameras may include, but are not limited to, digital cameras that may be adapted for use with the components and/or systems of the vehicle 100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 100 (e.g., front-facing cameras) may be used for surround view, to help identify forward facing paths and obstacles, as well aid in, with the help of one or more controllers 136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 170 that may be used to perceive objects coming into view from the periphery (e.g., pedestrians, crossing traffic or bicycles). Although only one wide-view camera is illustrated in FIG. 1B, there may be any number (including zero) of wide-view cameras 170 on the vehicle 100. In addition, any number of long-range camera(s) 198 (e.g., a long-view stereo camera pair) may be used for depth-based object detection, especially for objects for which a neural network has not yet been trained. The long-range camera(s) 198 may also be used for object detection and classification, as well as basic object tracking.

Any number of stereo cameras 168 may also be included in a front-facing configuration. In at least one embodiment, one or more of stereo camera(s) 168 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 168 may be used in addition to, or alternatively from, those described herein.

Cameras with a field of view that include portions of the environment to the side of the vehicle 100 (e.g., side-view cameras) may be used for surround view, providing information used to create and update the occupancy grid, as well as to generate side impact collision warnings. For example, surround camera(s) 174 (e.g., four surround cameras 174 as illustrated in FIG. 1B) may be positioned to on the vehicle 100. The surround camera(s) 174 may include wide-view camera(s) 170, fisheye camera(s), 360 degree camera(s), and/or the like. Four example, four fisheye cameras may be positioned on the vehicle's front, rear, and sides. In an alternative arrangement, the vehicle may use three surround camera(s) 174 (e.g., left, right, and rear), and may leverage one or more other camera(s) (e.g., a forward-facing camera) as a fourth surround view camera.

Cameras with a field of view that include portions of the environment to the rear of the vehicle 100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 198, stereo camera(s) 168), infrared camera(s) 172, etc.), as described herein.

FIG. 1C is a block diagram of an example system architecture for the example autonomous vehicle 100 of FIG. 1A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 100 in FIG. 1C are illustrated as being connected via bus 102. The bus 102 may include a Controller Area Network (CAN) data interface (alternatively referred to herein as a “CAN bus”). A CAN may be a network inside the vehicle 100 used to aid in control of various features and functionality of the vehicle 100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 102 is described herein as being a CAN bus, this is not intended to be limiting. For example, in addition to, or alternatively from, the CAN bus, FlexRay and/or Ethernet may be used. Additionally, although a single line is used to represent the bus 102, this is not intended to be limiting. For example, there may be any number of busses 102, which may include one or more CAN busses, one or more FlexRay busses, one or more Ethernet busses, and/or one or more other types of busses using a different protocol. In some examples, two or more busses 102 may be used to perform different functions, and/or may be used for redundancy. For example, a first bus 102 may be used for collision avoidance functionality and a second bus 102 may be used for actuation control. In any example, each bus 102 may communicate with any of the components of the vehicle 100, and two or more busses 102 may communicate with the same components. In some examples, each SoC 104, each controller 136, and/or each computer within the vehicle may have access to the same input data (e.g., inputs from sensors of the vehicle 100), and may be connected to a common bus, such the CAN bus.

The vehicle 100 may include one or more controller(s) 136, such as those described herein with respect to FIG. 1A. The controller(s) 136 may be used for a variety of functions. The controller(s) 136 may be coupled to any of the various other components and systems of the vehicle 100, and may be used for control of the vehicle 100, artificial intelligence of the vehicle 100, infotainment for the vehicle 100, and/or the like.

The vehicle 100 may include a system(s) on a chip (SoC) 104. The SoC 104 may include CPU(s) 106, GPU(s) 108, processor(s) 110, cache(s) 112, accelerator(s) 114, data store(s) 116, and/or other components and features not illustrated. The SoC(s) 104 may be used to control the vehicle 100 in a variety of platforms and systems. For example, the SoC(s) 104 may be combined in a system (e.g., the system of the vehicle 100) with an HD map 122 which may obtain map refreshes and/or updates via a network interface 124 from one or more servers (e.g., server(s) 178 of FIG. 1D).

The CPU(s) 106 may include a CPU cluster or CPU complex (alternatively referred to herein as a “CCPLEX”). The CPU(s) 106 may include multiple cores and/or L2 caches. For example, in some embodiments, the CPU(s) 106 may include eight cores in a coherent multi-processor configuration. In some embodiments, the CPU(s) 106 may include four dual-core clusters where each cluster has a dedicated L2 cache (e.g., a 2 MB L2 cache). The CPU(s) 106 (e.g., the CCPLEX) may be configured to support simultaneous cluster operation enabling any combination of the clusters of the CPU(s) 106 to be active at any given time.

The CPU(s) 106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 108 may include an integrated GPU (alternatively referred to herein as an “iGPU”). The GPU(s) 108 may be programmable and may be efficient for parallel workloads. The GPU(s) 108, in some examples, may use an enhanced tensor instruction set. The GPU(s) 108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 108 may include at least eight streaming microprocessors. The GPU(s) 108 may use compute application programming interface(s) (API(s)). In addition, the GPU(s) 108 may use one or more parallel computing platforms and/or programming models (e.g., NVIDIA's CUDA).

The GPU(s) 108 may be power-optimized for best performance in automotive and embedded use cases. For example, the GPU(s) 108 may be fabricated on a Fin field-effect transistor (FinFET). However, this is not intended to be limiting and the GPU(s) 108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 108 to access the CPU(s) 106 page tables directly. In such examples, when the GPU(s) 108 memory management unit (MMU) experiences a miss, an address translation request may be transmitted to the CPU(s) 106. In response, the CPU(s) 106 may look in its page tables for the virtual-to-physical mapping for the address and transmits the translation back to the GPU(s) 108. As such, unified memory technology may allow a single unified virtual address space for memory of both the CPU(s) 106 and the GPU(s) 108, thereby simplifying the GPU(s) 108 programming and porting of applications to the GPU(s) 108.

In addition, the GPU(s) 108 may include an access counter that may keep track of the frequency of access of the GPU(s) 108 to memory of other processors. The access counter may help ensure that memory pages are moved to the physical memory of the processor that is accessing the pages most frequently.

The SoC(s) 104 may include any number of cache(s) 112, including those described herein. For example, the cache(s) 112 may include an L3 cache that is available to both the CPU(s) 106 and the GPU(s) 108 (e.g., that is connected both the CPU(s) 106 and the GPU(s) 108). The cache(s) 112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 104 may include an arithmetic logic unit(s) (ALU(s)) which may be leveraged in performing processing with respect to any of the variety of tasks or operations of the vehicle 100—such as processing DNNs. In addition, the SoC(s) 104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 106 and/or GPU(s) 108.

The SoC(s) 104 may include one or more accelerators 114 (e.g., hardware accelerators, software accelerators, or a combination thereof). For example, the SoC(s) 104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 108 and to off-load some of the tasks of the GPU(s) 108 (e.g., to free up more cycles of the GPU(s) 108 for performing other tasks). As an example, the accelerator(s) 114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 108, and by using an inference accelerator, for example, a designer may target either the DLA(s) or the GPU(s) 108 for any function. For example, the designer may focus processing of CNNs and floating point operations on the DLA(s) and leave other functions to the GPU(s) 108 and/or other accelerator(s) 114.

The accelerator(s) 114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 114 (e.g., the hardware acceleration cluster) may include a computer vision network on-chip and SRAM, for providing a high-bandwidth, low latency SRAM for the accelerator(s) 114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 166 output that correlates with the vehicle 100 orientation, distance, 3D location estimates of the object obtained from the neural network and/or other sensors (e.g., LIDAR sensor(s) 164 or RADAR sensor(s) 160), among others.

The SoC(s) 104 may include data store(s) 116 (e.g., memory). The data store(s) 116 may be on-chip memory of the SoC(s) 104, which may store neural networks to be executed on the GPU and/or the DLA. In some examples, the data store(s) 116 may be large enough in capacity to store multiple instances of neural networks for redundancy and safety. The data store(s) 112 may comprise L2 or L3 cache(s) 112. Reference to the data store(s) 116 may include reference to the memory associated with the PVA, DLA, and/or other accelerator(s) 114, as described herein.

The SoC(s) 104 may include one or more processor(s) 110 (e.g., embedded processors). The processor(s) 110 may include a boot and power management processor that may be a dedicated processor and subsystem to handle boot power and management functions and related security enforcement. The boot and power management processor may be a part of the SoC(s) 104 boot sequence and may provide runtime power management services. The boot power and management processor may provide clock and voltage programming, assistance in system low power state transitions, management of SoC(s) 104 thermals and temperature sensors, and/or management of the SoC(s) 104 power states. Each temperature sensor may be implemented as a ring-oscillator whose output frequency is proportional to temperature, and the SoC(s) 104 may use the ring-oscillators to detect temperatures of the CPU(s) 106, GPU(s) 108, and/or accelerator(s) 114. If temperatures are determined to exceed a threshold, the boot and power management processor may enter a temperature fault routine and put the SoC(s) 104 into a lower power state and/or put the vehicle 100 into a chauffeur to safe stop mode (e.g., bring the vehicle 100 to a safe stop).

The processor(s) 110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 110 may further include a real-time camera engine that may include a dedicated processor subsystem for handling real-time camera management.

The processor(s) 110 may further include a high-dynamic range signal processor that may include an image signal processor that is a hardware engine that is part of the camera processing pipeline.

The processor(s) 110 may include a video image compositor that may be a processing block (e.g., implemented on a microprocessor) that implements video post-processing functions needed by a video playback application to produce the final image for the player window. The video image compositor may perform lens distortion correction on wide-view camera(s) 170, surround camera(s) 174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 108 is not required to continuously render new surfaces. Even when the GPU(s) 108 is powered on and active doing 3D rendering, the video image compositor may be used to offload the GPU(s) 108 to improve performance and responsiveness.

The SoC(s) 104 may further include a mobile industry processor interface (MIPI) camera serial interface for receiving video and input from cameras, a high-speed interface, and/or a video input block that may be used for camera and related pixel input functions. The SoC(s) 104 may further include an input/output controller(s) that may be controlled by software and may be used for receiving I/O signals that are uncommitted to a specific role.

The SoC(s) 104 may further include a broad range of peripheral interfaces to enable communication with peripherals, audio codecs, power management, and/or other devices. The SoC(s) 104 may be used to process data from cameras (e.g., connected over Gigabit Multimedia Serial Link and Ethernet), sensors (e.g., LIDAR sensor(s) 164, RADAR sensor(s) 160, etc. that may be connected over Ethernet), data from bus 102 (e.g., speed of vehicle 100, steering wheel position, etc.), data from GNSS sensor(s) 158 (e.g., connected over Ethernet or CAN bus). The SoC(s) 104 may further include dedicated high-performance mass storage controllers that may include their own DMA engines, and that may be used to free the CPU(s) 106 from routine data management tasks.

The SoC(s) 104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 104 may be faster, more reliable, and even more energy-efficient and space-efficient than conventional systems. For example, the accelerator(s) 114, when combined with the CPU(s) 106, the GPU(s) 108, and the data store(s) 116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 108.

In some examples, a CNN for facial recognition and vehicle owner identification may use data from camera sensors to identify the presence of an authorized driver and/or owner of the vehicle 100. The always on sensor processing engine may be used to unlock the vehicle when the owner approaches the driver door and turn on the lights, and, in security mode, to disable the vehicle when the owner leaves the vehicle. In this way, the SoC(s) 104 provide for security against theft and/or carjacking.

In another example, a CNN for emergency vehicle detection and identification may use data from microphones 196 to detect and identify emergency vehicle sirens. In contrast to conventional systems, that use general classifiers to detect sirens and manually extract features, the SoC(s) 104 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 162, until the emergency vehicle(s) passes.

The vehicle may include a CPU(s) 118 (e.g., discrete CPU(s), or dCPU(s)), that may be coupled to the SoC(s) 104 via a high-speed interconnect (e.g., PCIe). The CPU(s) 118 may include an X86 processor, for example. The CPU(s) 118 may be used to perform any of a variety of functions, including arbitrating potentially inconsistent results between ADAS sensors and the SoC(s) 104, and/or monitoring the status and health of the controller(s) 136 and/or infotainment SoC 130, for example.

The vehicle 100 may include a GPU(s) 120 (e.g., discrete GPU(s), or dGPU(s)), that may be coupled to the SoC(s) 104 via a high-speed interconnect (e.g., NVIDIA's NVLINK). The GPU(s) 120 may provide additional artificial intelligence functionality, such as by executing redundant and/or different neural networks, and may be used to train and/or update neural networks based on input (e.g., sensor data) from sensors of the vehicle 100.

The vehicle 100 may further include the network interface 124 which may include one or more wireless antennas 126 (e.g., one or more wireless antennas for different communication protocols, such as a cellular antenna, a Bluetooth antenna, etc.). The network interface 124 may be used to enable wireless connectivity over the Internet with the cloud (e.g., with the server(s) 178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 100 information about vehicles in proximity to the vehicle 100 (e.g., vehicles in front of, on the side of, and/or behind the vehicle 100). This functionality may be part of a cooperative adaptive cruise control functionality of the vehicle 100.

The network interface 124 may include a SoC that provides modulation and demodulation functionality and enables the controller(s) 136 to communicate over wireless networks. The network interface 124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 100 may further include data store(s) 128 which may include off-chip (e.g., off the SoC(s) 104) storage. The data store(s) 128 may include one or more storage elements including RAM, SRAM, DRAM, VRAM, Flash, hard disks, and/or other components and/or devices that may store at least one bit of data.

The vehicle 100 may further include GNSS sensor(s) 158. The GNSS sensor(s) 158 (e.g., GPS, assisted GPS sensors, differential GPS (DGPS) sensors, etc.), to assist in mapping, perception, occupancy grid generation, and/or path planning functions. Any number of GNSS sensor(s) 158 may be used, including, for example and without limitation, a GPS using a USB connector with an Ethernet to Serial (RS-232) bridge.

The vehicle 100 may further include RADAR sensor(s) 160. The RADAR sensor(s) 160 may be used by the vehicle 100 for long-range vehicle detection, even in darkness and/or severe weather conditions. RADAR functional safety levels may be ASIL B. The RADAR sensor(s) 160 may use the CAN and/or the bus 102 (e.g., to transmit data generated by the RADAR sensor(s) 160) for control and to access object tracking data, with access to Ethernet to access raw data in some examples. A wide variety of RADAR sensor types may be used. For example, and without limitation, the RADAR sensor(s) 160 may be suitable for front, rear, and side RADAR use. In some example, Pulse Doppler RADAR sensor(s) are used.

The RADAR sensor(s) 160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250m range. The RADAR sensor(s) 160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 100 surroundings at higher speeds with minimal interference from traffic in adjacent lanes. The other two antennae may expand the field of view, making it possible to quickly detect vehicles entering or leaving the vehicle's 100 lane.

Mid-range RADAR systems may include, as an example, a range of up to 160m (front) or 80m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 100 may further include ultrasonic sensor(s) 162. The ultrasonic sensor(s) 162, which may be positioned at the front, back, and/or the sides of the vehicle 100, may be used for park assist and/or to create and update an occupancy grid. A wide variety of ultrasonic sensor(s) 162 may be used, and different ultrasonic sensor(s) 162 may be used for different ranges of detection (e.g., 2.5m, 4m). The ultrasonic sensor(s) 162 may operate at functional safety levels of ASIL B.

The vehicle 100 may include LIDAR sensor(s) 164. The LIDAR sensor(s) 164 may be used for object and pedestrian detection, emergency braking, collision avoidance, and/or other functions. The LIDAR sensor(s) 164 may be functional safety level ASIL B. In some examples, the vehicle 100 may include multiple LIDAR sensors 164 (e.g., two, four, six, etc.) that may use Ethernet (e.g., to provide data to a Gigabit Ethernet switch).

In some examples, the LIDAR sensor(s) 164 may be capable of providing a list of objects and their distances for a 360-degree field of view. Commercially available LIDAR sensor(s) 164 may have an advertised range of approximately 100m, with an accuracy of 2 cm-3 cm, and with support for a 100 Mbps Ethernet connection, for example. In some examples, one or more non-protruding LIDAR sensors 164 may be used. In such examples, the LIDAR sensor(s) 164 may be implemented as a small device that may be embedded into the front, rear, sides, and/or corners of the vehicle 100. The LIDAR sensor(s) 164, in such examples, may provide up to a 120-degree horizontal and 35-degree vertical field-of-view, with a 200m range even for low-reflectivity objects. Front-mounted LIDAR sensor(s) 164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 164 may be less susceptible to motion blur, vibration, and/or shock.

The vehicle may further include IMU sensor(s) 166. The IMU sensor(s) 166 may be located at a center of the rear axle of the vehicle 100, in some examples. The IMU sensor(s) 166 may include, for example and without limitation, an accelerometer(s), a magnetometer(s), a gyroscope(s), a magnetic compass(es), and/or other sensor types. In some examples, such as in six-axis applications, the IMU sensor(s) 166 may include accelerometers and gyroscopes, while in nine-axis applications, the IMU sensor(s) 166 may include accelerometers, gyroscopes, and magnetometers.

In some embodiments, the IMU sensor(s) 166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 166 may enable the vehicle 100 to estimate heading without requiring input from a magnetic sensor by directly observing and correlating the changes in velocity from GPS to the IMU sensor(s) 166. In some examples, the IMU sensor(s) 166 and the GNSS sensor(s) 158 may be combined in a single integrated unit.

The vehicle may include microphone(s) 196 placed in and/or around the vehicle 100. The microphone(s) 196 may be used for emergency vehicle detection and identification, among other things.

The vehicle may further include any number of camera types, including stereo camera(s) 168, wide-view camera(s) 170, infrared camera(s) 172, surround camera(s) 174, long-range and/or mid-range camera(s) 198, and/or other camera types. The cameras may be used to capture image data around an entire periphery of the vehicle 100. The types of cameras used depends on the embodiments and requirements for the vehicle 100, and any combination of camera types may be used to provide the necessary coverage around the vehicle 100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 1A and FIG. 1B.

The vehicle 100 may further include vibration sensor(s) 142. The vibration sensor(s) 142 may measure vibrations of components of the vehicle, such as the axle(s). For example, changes in vibrations may indicate a change in road surfaces. In another example, when two or more vibration sensors 142 are used, the differences between the vibrations may be used to determine friction or slippage of the road surface (e.g., when the difference in vibration is between a power-driven axle and a freely rotating axle).

The vehicle 100 may include an ADAS system 138. The ADAS system 138 may include a SoC, in some examples. The ADAS system 138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 160, LIDAR sensor(s) 164, and/or a camera(s). The ACC systems may include longitudinal ACC and/or lateral ACC. Longitudinal ACC monitors and controls the distance to the vehicle immediately ahead of the vehicle 100 and automatically adjust the vehicle speed to maintain a safe distance from vehicles ahead. Lateral ACC performs distance keeping, and advises the vehicle 100 to change lanes when necessary. Lateral ACC is related to other ADAS applications such as LCA and CWS.

CACC uses information from other vehicles that may be received via the network interface 124 and/or the wireless antenna(s) 126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 100), while the I2V communication concept provides information about traffic further ahead. CACC systems may include either or both I2V and V2V information sources. Given the information of the vehicles ahead of the vehicle 100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 100 if the vehicle 100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 100 is backing up. Some RCTW systems include AEB to ensure that the vehicle brakes are applied to avoid a crash. RCTW systems may use one or more rear-facing RADAR sensor(s) 160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 100, the vehicle 100 itself must, in the case of conflicting results, decide whether to heed the result from a primary computer or a secondary computer (e.g., a first controller 136 or a second controller 136). For example, in some embodiments, the ADAS system 138 may be a backup and/or secondary computer for providing perception information to a backup computer rationality module. The backup computer rationality monitor may run a redundant diverse software on hardware components to detect faults in perception and dynamic driving tasks. Outputs from the ADAS system 138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 104.

In other examples, ADAS system 138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 138 may be fed into the primary computer's perception block and/or the primary computer's dynamic driving task block. For example, if the ADAS system 138 indicates a forward crash warning due to an object immediately ahead, the perception block may use this information when identifying objects. In other examples, the secondary computer may have its own neural network which is trained and thus reduces the risk of false positives, as described herein.

The vehicle 100 may further include the infotainment SoC 130 (e.g., an in-vehicle infotainment system (IVI)). Although illustrated and described as a SoC, the infotainment system may not be a SoC, and may include two or more discrete components. The infotainment SoC 130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 100. For example, the infotainment SoC 130 may radios, disk players, navigation systems, video players, USB and Bluetooth connectivity, carputers, in-car entertainment, Wi-Fi, steering wheel audio controls, hands free voice control, a heads-up display (HUD), an HMI display 134, a telematics device, a control panel (e.g., for controlling and/or interacting with various components, features, and/or systems), and/or other components. The infotainment SoC 130 may further be used to provide information (e.g., visual and/or audible) to a user(s) of the vehicle, such as information from the ADAS system 138, autonomous driving information such as planned vehicle maneuvers, trajectories, surrounding environment information (e.g., intersection information, vehicle information, road information, etc.), and/or other information.

The infotainment SoC 130 may include GPU functionality. The infotainment SoC 130 may communicate over the bus 102 (e.g., CAN bus, Ethernet, etc.) with other devices, systems, and/or components of the vehicle 100. In some examples, the infotainment SoC 130 may be coupled to a supervisory MCU such that the GPU of the infotainment system may perform some self-driving functions in the event that the primary controller(s) 136 (e.g., the primary and/or backup computers of the vehicle 100) fail. In such an example, the infotainment SoC 130 may put the vehicle 100 into a chauffeur to safe stop mode, as described herein.

The vehicle 100 may further include an instrument cluster 132 (e.g., a digital dash, an electronic instrument cluster, a digital instrument panel, etc.). The instrument cluster 132 may include a controller and/or supercomputer (e.g., a discrete controller or supercomputer). The instrument cluster 132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 130 and the instrument cluster 132. In other words, the instrument cluster 132 may be included as part of the infotainment SoC 130, or vice versa.

FIG. 1D is a system diagram for communication between cloud-based server(s) and the example autonomous vehicle 100 of FIG. 1A, in accordance with some embodiments of the present disclosure. The system 176 may include server(s) 178, network(s) 190, and vehicles, including the vehicle 100. The server(s) 178 may include a plurality of GPUs 184(A)-184(H) (collectively referred to herein as GPUs 184), PCIe switches 182(A)-182(H) (collectively referred to herein as PCIe switches 182), and/or CPUs 180(A)-180(B) (collectively referred to herein as CPUs 180). The GPUs 184, the CPUs 180, and the PCIe switches may be interconnected with high-speed interconnects such as, for example and without limitation, NVLink interfaces 188 developed by NVIDIA and/or PCIe connections 186. In some examples, the GPUs 184 are connected via NVLink and/or NVSwitch SoC and the GPUs 184 and the PCIe switches 182 are connected via PCIe interconnects. Although eight GPUs 184, two CPUs 180, and two PCIe switches are illustrated, this is not intended to be limiting. Depending on the embodiment, each of the server(s) 178 may include any number of GPUs 184, CPUs 180, and/or PCIe switches. For example, the server(s) 178 may each include eight, sixteen, thirty-two, and/or more GPUs 184.

The server(s) 178 may receive, over the network(s) 190 and from the vehicles, image data representative of images showing unexpected or changed road conditions, such as recently commenced road-work. The server(s) 178 may transmit, over the network(s) 190 and to the vehicles, neural networks 192, updated neural networks 192, and/or map information 194, including information regarding traffic and road conditions. The updates to the map information 194 may include updates for the HD map 122, such as information regarding construction sites, potholes, detours, flooding, and/or other obstructions. In some examples, the neural networks 192, the updated neural networks 192, and/or the map information 194 may have resulted from new training and/or experiences represented in data received from any number of vehicles in the environment, and/or based on training performed at a datacenter (e.g., using the server(s) 178 and/or other servers).

The server(s) 178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 190, and/or the machine learning models may be used by the server(s) 178 to remotely monitor the vehicles.

In some examples, the server(s) 178 may receive data from the vehicles and apply the data to up-to-date real-time neural networks for real-time intelligent inferencing. The server(s) 178 may include deep-learning supercomputers and/or dedicated AI computers powered by GPU(s) 184, such as a DGX and DGX Station machines developed by NVIDIA. However, in some examples, the server(s) 178 may include deep learning infrastructure that use only CPU-powered datacenters.

The deep-learning infrastructure of the server(s) 178 may be capable of fast, real-time inferencing, and may use that capability to evaluate and verify the health of the processors, software, and/or associated hardware in the vehicle 100. For example, the deep-learning infrastructure may receive periodic updates from the vehicle 100, such as a sequence of images and/or objects that the vehicle 100 has located in that sequence of images (e.g., via computer vision and/or other machine learning object classification techniques). The deep-learning infrastructure may run its own neural network to identify the objects and compare them with the objects identified by the vehicle 100 and, if the results do not match and the infrastructure concludes that the AI in the vehicle 100 is malfunctioning, the server(s) 178 may transmit a signal to the vehicle 100 instructing a fail-safe computer of the vehicle 100 to assume control, notify the passengers, and complete a safe parking maneuver.

For inferencing, the server(s) 178 may include the GPU(s) 184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 2 is a block diagram of an example computing device(s) 200 suitable for use in implementing some embodiments of the present disclosure. Computing device 200 may include an interconnect system 202 that directly or indirectly couples the following devices: memory 204, one or more central processing units (CPUs) 206, one or more graphics processing units (GPUs) 208, a communication interface 210, input/output (I/O) ports 212, input/output components 214, a power supply 216, one or more presentation components 218 (e.g., display(s)), and one or more logic units 220. In at least one embodiment, the computing device(s) 200 may comprise one or more virtual machines (VMs), and/or any of the components thereof may comprise virtual components (e.g., virtual hardware components). For non-limiting examples, one or more of the GPUs 208 may comprise one or more vGPUs, one or more of the CPUs 206 may comprise one or more vCPUs, and/or one or more of the logic units 220 may comprise one or more virtual logic units. As such, a computing device(s) 200 may include discrete components (e.g., a full GPU dedicated to the computing device 200), virtual components (e.g., a portion of a GPU dedicated to the computing device 200), or a combination thereof.

Although the various blocks of FIG. 2 are shown as connected via the interconnect system 202 with lines, this is not intended to be limiting and is for clarity only. For example, in some embodiments, a presentation component 218, such as a display device, may be considered an I/O component 214 (e.g., if the display is a touch screen). As another example, the CPUs 206 and/or GPUs 208 may include memory (e.g., the memory 204 may be representative of a storage device in addition to the memory of the GPUs 208, the CPUs 206, and/or other components). In other words, the computing device of FIG. 2 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 2.

The interconnect system 202 may represent one or more links or busses, such as an address bus, a data bus, a control bus, or a combination thereof. The interconnect system 202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 206 may be directly connected to the memory 204. Further, the CPU 206 may be directly connected to the GPU 208. Where there is direct, or point-to-point connection between components, the interconnect system 202 may include a PCIe link to carry out the connection. In these examples, a PCI bus need not be included in the computing device 200.

The memory 204 may include any of a variety of computer-readable media. The computer-readable media may be any available media that may be accessed by the computing device 200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 206 may be configured to execute at least some of the computer-readable instructions to control one or more components of the computing device 200 to perform one or more of the methods and/or processes described herein. The CPU(s) 206 may each include one or more cores (e.g., one, two, four, eight, twenty-eight, seventy-two, etc.) that are capable of handling a multitude of software threads simultaneously. The CPU(s) 206 may include any type of processor, and may include different types of processors depending on the type of computing device 200 implemented (e.g., processors with fewer cores for mobile devices and processors with more cores for servers). For example, depending on the type of computing device 200, the processor may be an Advanced RISC Machines (ARM) processor implemented using Reduced Instruction Set Computing (RISC) or an x86 processor implemented using Complex Instruction Set Computing (CISC). The computing device 200 may include one or more CPUs 206 in addition to one or more microprocessors or supplementary co-processors, such as math co-processors.

In addition to or alternatively from the CPU(s) 206, the GPU(s) 208 may be configured to execute at least some of the computer-readable instructions to control one or more components of the computing device 200 to perform one or more of the methods and/or processes described herein. One or more of the GPU(s) 208 may be an integrated GPU (e.g., with one or more of the CPU(s) 206 and/or one or more of the GPU(s) 208 may be a discrete GPU. In embodiments, one or more of the GPU(s) 208 may be a coprocessor of one or more of the CPU(s) 206. The GPU(s) 208 may be used by the computing device 200 to render graphics (e.g., 3D graphics) or perform general purpose computations. For example, the GPU(s) 208 may be used for General-Purpose computing on GPUs (GPGPU). The GPU(s) 208 may include hundreds or thousands of cores that are capable of handling hundreds or thousands of software threads simultaneously. The GPU(s) 208 may generate pixel data for output images in response to rendering commands (e.g., rendering commands from the CPU(s) 206 received via a host interface). The GPU(s) 208 may include graphics memory, such as display memory, for storing pixel data or any other suitable data, such as GPGPU data. The display memory may be included as part of the memory 204. The GPU(s) 208 may include two or more GPUs operating in parallel (e.g., via a link). The link may directly connect the GPUs (e.g., using NVLINK) or may connect the GPUs through a switch (e.g., using NVSwitch). When combined together, each GPU 208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 206 and/or the GPU(s) 208, the logic unit(s) 220 may be configured to execute at least some of the computer-readable instructions to control one or more components of the computing device 200 to perform one or more of the methods and/or processes described herein. In embodiments, the CPU(s) 206, the GPU(s) 208, and/or the logic unit(s) 220 may discretely or jointly perform any combination of the methods, processes and/or portions thereof. One or more of the logic units 220 may be part of and/or integrated in one or more of the CPU(s) 206 and/or the GPU(s) 208 and/or one or more of the logic units 220 may be discrete components or otherwise external to the CPU(s) 206 and/or the GPU(s) 208. In embodiments, one or more of the logic units 220 may be a coprocessor of one or more of the CPU(s) 206 and/or one or more of the GPU(s) 208.

Examples of the logic unit(s) 220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 210 may include one or more receivers, transmitters, and/or transceivers that enable the computing device 200 to communicate with other computing devices via an electronic communication network, included wired and/or wireless communications. The communication interface 210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 220 and/or communication interface 210 may include one or more data processing units (DPUs) to transmit data received over a network and/or through interconnect system 202 directly to (e.g., a memory of) one or more GPU(s) 208.

The I/O ports 212 may enable the computing device 200 to be logically coupled to other devices including the I/O components 214, the presentation component(s) 218, and/or other components, some of which may be built in to (e.g., integrated in) the computing device 200. Illustrative I/O components 214 include a microphone, mouse, keyboard, joystick, game pad, game controller, satellite dish, scanner, printer, wireless device, etc. The I/O components 214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 200. The computing device 200 may be include depth cameras, such as stereoscopic camera systems, infrared camera systems, RGB camera systems, touchscreen technology, and combinations of these, for gesture detection and recognition. Additionally, the computing device 200 may include accelerometers or gyroscopes (e.g., as part of an inertia measurement unit (IMU)) that enable detection of motion. In some examples, the output of the accelerometers or gyroscopes may be used by the computing device 200 to render immersive augmented reality or virtual reality.

The power supply 216 may include a hard-wired power supply, a battery power supply, or a combination thereof. The power supply 216 may provide power to the computing device 200 to enable the components of the computing device 200 to operate.

The presentation component(s) 218 may include a display (e.g., a monitor, a touch screen, a television screen, a heads-up-display (HUD), other display types, or a combination thereof), speakers, and/or other presentation components. The presentation component(s) 218 may receive data from other components (e.g., the GPU(s) 208, the CPU(s) 206, DPUs, etc.), and output the data (e.g., as an image, video, sound, etc.).

### Example Data Center

FIG. 3 illustrates an example data center 300 that may be used in at least one embodiments of the present disclosure. The data center 300 may include a data center infrastructure layer 310, a framework layer 320, a software layer 330, and/or an application layer 340.

As shown in FIG. 3, the data center infrastructure layer 310 may include a resource orchestrator 312, grouped computing resources 314, and node computing resources (“node C.R.s”) 316(1)-316(N), where “N” represents any whole, positive integer. In at least one embodiment, node C.R.s 316(1)-316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 316(1)-316(N) may correspond to a server having one or more of the above-mentioned computing resources. In addition, in some embodiments, the node C.R.s 316(1)-3161(N) may include one or more virtual components, such as vGPUs, vCPUs, and/or the like, and/or one or more of the node C.R.s 316(1)-316(N) may correspond to a virtual machine (VM).

In at least one embodiment, grouped computing resources 314 may include separate groupings of node C.R.s 316 housed within one or more racks (not shown), or many racks housed in data centers at various geographical locations (also not shown). Separate groupings of node C.R.s 316 within grouped computing resources 314 may include grouped compute, network, memory or storage resources that may be configured or allocated to support one or more workloads. In at least one embodiment, several node C.R.s 316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 312 may configure or otherwise control one or more node C.R.s 316(1)-316(N) and/or grouped computing resources 314. In at least one embodiment, resource orchestrator 312 may include a software design infrastructure (SDI) management entity for the data center 300. The resource orchestrator 312 may include hardware, software, or some combination thereof.

In at least one embodiment, as shown in FIG. 3, framework layer 320 may include a job scheduler 333, a configuration manager 334, a resource manager 336, and/or a distributed file system 338. The framework layer 320 may include a framework to support software 332 of software layer 330 and/or one or more application(s) 342 of application layer 340. The software 332 or application(s) 342 may respectively include web-based service software or applications, such as those provided by Amazon Web Services, Google Cloud and Microsoft Azure. The framework layer 320 may be, but is not limited to, a type of free and open-source software web application framework such as Apache Spark™ (hereinafter “Spark”) that may use distributed file system 338 for large-scale data processing (e.g., “big data”). In at least one embodiment, job scheduler 333 may include a Spark driver to facilitate scheduling of workloads supported by various layers of data center 300. The configuration manager 334 may be capable of configuring different layers such as software layer 330 and framework layer 320 including Spark and distributed file system 338 for supporting large-scale data processing. The resource manager 336 may be capable of managing clustered or grouped computing resources mapped to or allocated for support of distributed file system 338 and job scheduler 333. In at least one embodiment, clustered or grouped computing resources may include grouped computing resource 314 at data center infrastructure layer 310. The resource manager 336 may coordinate with resource orchestrator 312 to manage these mapped or allocated computing resources.

In at least one embodiment, software 332 included in software layer 330 may include software used by at least portions of node C.R.s 316(1)-316(N), grouped computing resources 314, and/or distributed file system 338 of framework layer 320. One or more types of software may include, but are not limited to, Internet web page search software, e-mail virus scan software, database software, and streaming video content software.

In at least one embodiment, application(s) 342 included in application layer 340 may include one or more types of applications used by at least portions of node C.R.s 316(1)-316(N), grouped computing resources 314, and/or distributed file system 338 of framework layer 320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 334, resource manager 336, and resource orchestrator 312 may implement any number and type of self-modifying actions based on any amount and type of data acquired in any technically feasible fashion. Self-modifying actions may relieve a data center operator of data center 300 from making possibly bad configuration decisions and possibly avoiding underutilized and/or poor performing portions of a data center.

The data center 300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 300. In at least one embodiment, trained or deployed machine learning models corresponding to one or more neural networks may be used to infer or predict information using resources described above with respect to the data center 300 by using weight parameters calculated through one or more training techniques, such as but not limited to those described herein.

In at least one embodiment, the data center 300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 200 of FIG. 2—e.g., each device may include similar components, features, and/or functionality of the computing device(s) 200. In addition, where backend devices (e.g., servers, NAS, etc.) are implemented, the backend devices may be included as part of a data center 300, an example of which is described in more detail herein with respect to FIG. 3.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 200 described herein with respect to FIG. 2. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

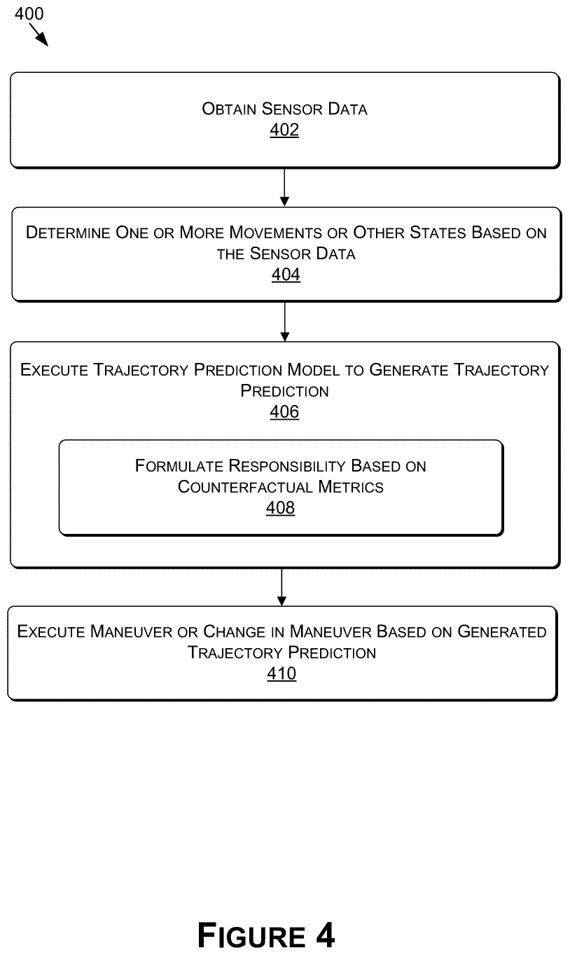

Now referring to FIG. 4, each block of method 400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. Although method 400 may be described, by way of example, with respect to an autonomous vehicle, these methods may additionally or alternatively be executed by any one system, or any combination of systems, including, but not limited to, those described herein.

FIG. 4 is a flow diagram showing a method 400 for an interpretable trajectory prediction model, in accordance with some embodiments of the present disclosure. The method 400, at block 402, includes obtaining sensor data. The sensor data may be based on, and/or derived from, measurements captured using one or more sensors. One or more of the sensors may be part of, under the control of, and/or in communication with an autonomous or semiautonomous system (used interchangeably with “system”). Additionally or alternatively, one or more of the sensors may be separate from the system, but otherwise capable of taking measurements regarding the system or the surroundings of the system. The sensor data may be used to determine the presence, position, and/or movement of agents and objects in the system's surroundings. Method 400, at block 404, includes determining one or more states (e.g., a location, speed, and/or movement of a vehicle in the system's surroundings) of an agent in the system's surroundings. For example, a sensor may provide a sequence of readings that indicate, based on changes in position, that a vehicle near the system is traveling in a certain direction and/or at a particular speed.

Method 400, at block 406, includes executing a trajectory prediction model to generate a trajectory prediction. The generated trajectory prediction may be a prediction of a trajectory of an agent near enough to the system to be relevant to the system (e.g., because the agent could feasibly collide with the system depending on the behavior of the agent). The trajectory prediction model, as will be further discussed herein, may (at block 408) quantify a responsibility of one or more agents near the system. Responsibility may be quantified, for example, based on counterfactual metrics, such as safety and courtesy, as will be further discussed below. Method 400, at block 410, may include executing one or more maneuvers, and/or one or more changes in one or more maneuvers, based on the generated trajectory prediction. The system may, for example, change course to safely avoid a collision with the agent based on a prediction that the agent's trajectory will bring the agent too close to the system.

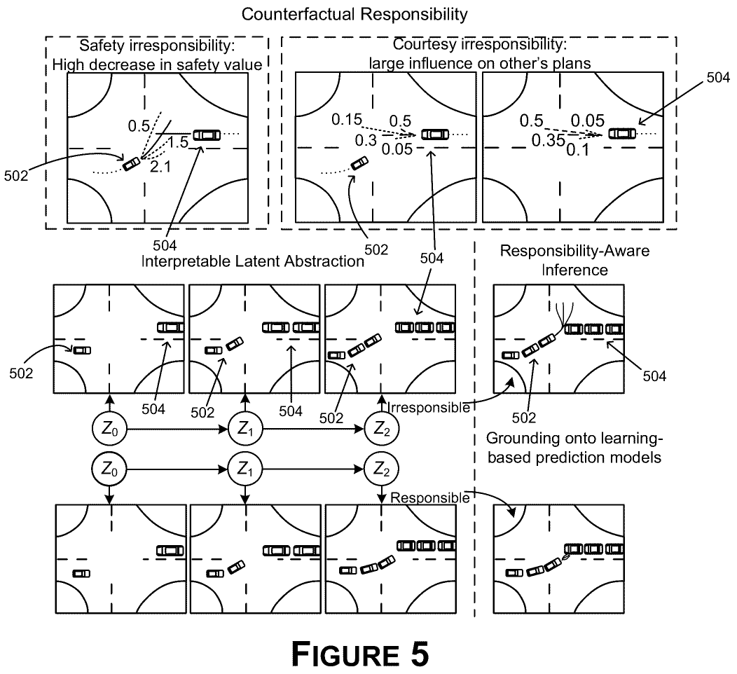

FIG. 5 depicts an example interpretability framework for a wide range of phenomenological trajectory prediction methods through responsibility evaluations, in accordance with some embodiments. The top of FIG. 5 illustrates that responsibility may be formulated by using counterfactual reasoning to evaluate how much an agent (vehicle 502) prioritizes the wellbeing of other road users (vehicle 504). This involves assessing the agent's level of regard for the safety of other drivers, as indicated by the deviation to which it adheres to safety margins compared to alternative strategies. Additionally, the extent to which the agent's actions may disrupt the plans of other drivers is considered, as indicated by the probability of strategies (numbers next to trajectories). The bottom of FIG. 5 illustrates that the hierarchical framework projects these responsibility metrics to latent features and grounds these features into a learning-based trajectory prediction model to obtain accurate but interpretable inferences.

The concept of responsibility is inherent in human actions and is enforced by legal systems. Therefore, responsibility can be an informative indicator for an interpretable prediction of the potential movements of neighboring agents. Responsibility may be formalized through counterfactual reasoning. Embodiments of the disclosed approach consider whether an agent could have taken alternative motions to be more considerate towards its neighbors. In various embodiments, a method for determining alternate motions, based on a phenomenological traffic model, is used to generates realistic and diverse motions. A set of potential motions may be built using predictions from the traffic model. Responsibility metrics may then be computed by analyzing how much a particular agent cares about the welfare of its neighbors by comparing the executed motion with other possible plans from the traffic model.

Motion set synthesis: Example embodiments construct a set of open-loop motions by using a data-driven traffic model π_{θ} since it can generate realistic and multimodal behaviors. The traffic model can be trained with real-world traffic logs in a supervised learning manner. Considering at each time step k, example embodiments have a context variable

$${x}_{k} := ( {m}_{k} , {s}_{k - {T}_{h} : k}^{( 0 : N )} ) ,$$

where mₖ is a local semantic map and,

$${s}_{k - {T}_{h} : k}^{( 0 , N )} := \{ {s}_{k - {T}_{h} : k}^{( 0 )} , … , {s}_{k - {T}_{h} : k}^{( N )} \}$$

are the state history with horizon Tₕ of the agent ( [symbol] ⁽ⁱ⁾) and its neighbors ( [symbol] ⁻ⁱ:= [symbol] ^{(0, . . . ,i-1,i+1, . . . ,N)}) The output of the example traffic model is a conditional distribution π_{θ} (u_{k:k+T}_{_{f}}⁽ⁱ⁾|xₖ,i) over the future motion with horizon T_{f} of the agent.

The distribution over motions allows for generation of dynamically-feasible trajectories by integrating the agents' dynamics f⁽ⁱ⁾ with the motion. Then, example embodiments can construct the open-loop motion set and its corresponding trajectory set by sampling motions from the traffic model π_{θ}:

$${𝕌}_{k}^{( i )} ( {x}_{k} ) := \{ {u}_{k : k + T f}^{( i )} ∼ {π}_{θ} ( \cdot \vert {x}_{k} , i ) \} , \qquad ( 1 a )$$

$${Ξ}_{k}^{( i )} ( {x}_{k} ) := \{ {ξ}^{{s}_{k}^{( i )} , u , {f}^{( i )}} \vert ∀ u ∈ {𝕌}_{k}^{( i )} ( {x}_{k} ) \} , \qquad ( 1 b )$$

where ξ^{s,u,f}:{0,1, . . . ,T_{f}}→ [symbol] ² denotes x-y positions of the trajectory starting from state s following dynamics funder motion u. It is noted that, motion and trajectory are sometimes used interchangeably, as a motion is sampled from the output of the traffic model and the dynamics can be integrated with the open-loop motion to obtain a trajectory.

Responsibility formulation: Responsible agents should consider the welfare of their surrounding agents. Specifically, they exercise reasonable plans to avoid colliding and influencing others' behavior dramatically. Thus, example embodiments formulate responsibility by answering two counterfactual questions: (1) Safety responsibility: does the motion plan of the queried agent [symbol] ^{(a)} maintain a larger distance margin towards the target agent [symbol] ^{(b)} compared to other motions in the set sampled from the traffic model as in (1)? and (2) Courtesy responsibility: would the target agent's motions differ significantly if the queried agent were not present in the scene? Thus, an AV or other autonomous system can estimate the queried agent's responsibility and use this additional information for more accurate and interpretable trajectory prediction, which is described below.

To answer the first question, example embodiments construct a safety outcome function:

$${D}_{g} ( ξ , {ξ}^{′} ) := \begin{matrix}min \\ k ∈ \{ 1 , 2 , … , {T}_{f} \}\end{matrix} ‖ {ξ}_{k} - {ξ}_{k}^{′} ‖ 2 , \qquad ( 2 )$$

which measures the closest distance between two trajectories ξ and ξ′ in L² norm. The example embodiments then compute the distribution of safety value decrease based on Ξₖ^{(a)}(xₖ):

$$C ( a , b , {x}_{k} ) := \{ {D}_{g} ( ξ , {ξ}^{( b )} ) - {D}_{g} ( {ξ}^{( a )} , {ξ}^{( b )} ) \vert ξ ∈ {Ξ}_{k}^{( a )} ( {x}_{k} ) \} ,$$

where ξ⁽ⁱ⁾ represents the real trajectory of agent [symbol] ⁽ⁱ⁾ from the traffic log.

Example embodiments employ conditional value-at-risk (CVaR) to quantify how much the queried agent cares about safety when it can maintain a more considerable safety outcome D_{g}. CVaR, or expected shortfall, is a risk measure used in portfolio optimization in the financial market. CVaR at level α is the expected cost in the worst a-percentile of C under

$$p ( C \leq c ) = \frac{\vert \{ {c}^{′} ∈ C \vert {c}^{′} \leq c \} \vert}{\vert C \vert}$$

and formally defined as:

$$C V a {R}_{α} ( C ) := \frac{{\int }_{1 - α}^{1} V a {R}_{1 - γ} ( C ) d γ}{α} ,$$

where VaR_{α}(C):=inf{c∈ [symbol] |p(C≤c)≥1−α} is the value-at-risk at level α such that the probability of a loss greater than VaR_{α}(C) is (at most) a while the probability of a loss less than VaR_{α}(C) is (at least) 1−α.

Specifically, the safety responsibility of the queried agent [symbol] ^{(a)} with respect to the target agent [symbol] ^{(b)} with scene context x is defined as:

$${β}_{k}^{safety} ( a , b , {x}_{k} ) := CVa {R}_{α} ( C ( a , b , {x}_{k} ) ) \qquad ( 3 )$$

In the extreme case when α→1, the safety responsibility is the maximum safety outcome decrease i.e., βₖ^{safety}(a, b, xₖ)=max_{ξΞ}_{^{(a)}}₍ₓ_{ₖ}₎D_{g} (ξ, ξ^{(b)})−D_{g} (ξ^{(a)}, ξ^{(b)}). The top left subfigure in FIG. 5 demonstrates that the executed plan (502) is irresponsible as there are other control strategies that can maintain a more considerable safety margin toward the road user (504) (e.g., a high safety decrease, illustrated by the numbers corresponding to different trajectories).

On the other hand, example embodiments model courtesy responsibility as the difference in the distributions of the target agent's motion with and without the queried agent. Example embodiments compute the courtesy responsibility as follows:

$${β}_{k}^{courtesy} ( a , b , {x}_{k} ) := {D}_{K L} ( {π}_{θ} ( \cdot \vert {x}_{k} , b ) ‖ {π}_{θ} ( \cdot \vert {x}_{k}^{- a} , b ) ) , \qquad ( 4 )$$

where superscript xₖ^{-a} denotes removing the trajectory history of the queried agent and D_{KL} is the Kullback-Leibler (KL) divergence. This metric quantifies the extent to which the queried agent influences the possible motions of the target agent. The top right portion of FIG. 5 demonstrates that road user 502 is irresponsible as their plan largely influences the distribution of road user 504's plans. The probabilities are shown near the trajectories.

In example embodiments, the responsibility of the queried agent is defined as the worst responsibility concerning all its neighbors:

$${β}_{k}^{safety} ( a , {x}_{k} ) = {β}_{k}^{safety} ( a , b , {x}_{k} ) , \qquad ( 5 )$$

$${β}_{k}^{c o u r t e s y} ( a , {x}_{k} ) = {β}_{k}^{c o u r t e s y} ( a , b , {x}_{k} ) .$$

Interpretable trajectory prediction through responsibility grounding: With the two responsibility metrics defined in equations (3) and (4), example embodiments employ a hierarchical framework to leverage them to render interpretable trajectory predictions. The bottom of FIG. 5 shows the overview of the proposed hierarchical framework in accordance with some embodiments. In the first stage, example embodiments demonstrate the abstracting sequences of calculated responsibility metrics into various responsibility levels. Each responsibility level signifies different interaction intentions, making it valuable for ex-post traffic analysis. In the second stage, example embodiments incorporate these interpretable latent levels into trajectory prediction models through learning responsibility-dependent reward functions. To simplify the notation, the discussion will focus on a single queried agent and omit the dependency on [symbol] ^{(a)}, i.e., βₖ:=[βₖ^{safety}, βₖ^{courtesy}]^{T}.

Interpretable latent abstraction: In the first stage of the framework, example embodiments simplify the sequences of calculated responsibility metrics into distinct levels, with the assumption that agents' responsibility can be represented in discrete levels for tractability. This representation can circumvent noisy observations in the traffic log and may be a more natural fit for more complex reasoning and planning. Additionally, the responsibility metrics can have a long-range dependency in time. Therefore, example embodiments employ a hidden Markov model (HMM) to view responsibility metrics as noisy observations and mitigate the long-term dependency with discrete latent responsibility levels. First, example embodiments label the traffic logs with responsibility observation sequences by (3) and (4). Then, example embodiments learn the parameters of HMM of H responsibility levels (ρ, A, B),

$$ρ = \{ {ρ}_{i} \} ∈ {ℝ}^{H} , {ρ}_{i} = p ( {z}_{0} = i )$$

$$A = \{ {a}_{i j} \} ∈ {ℝ}^{H \times H} , {a}_{i j} = p ( {z}_{k + 1} = j ‖ {z}_{k} = i )$$

$$B = \{ {b}_{h} ( β ) \} , h ∈ \{ 0 , 1 , … H - 1 \} ,$$

$${b}_{h} ( β ) = p ( {β}_{k} = β \vert {z}_{k} = h )$$

where ρ is the distribution of initial hidden level, A is the transition matrix with aᵢⱼ the probability of going from state i to state j at the next timestep, and B is the set of level-conditioned emission distributions with bₕ(β) the probability of the observation given the mode h. After the HMM parameters were learned, the distribution of hidden responsibility level at timestep k can be computed by the forwards algorithm, and the most likely hidden responsibility level can be obtained by Bayes rule:

$$\begin{matrix}{z}_{k} = {arg max}_{z ∈ \{ 0 , 1 , … , H - 1 \}} \frac{p ( {β}_{k} \vert z ) p ( z \vert {β}_{1 : k - 1} )}{{\sum }_{{z}^{′} ∈ \{ 0 , 1 , … , H - 1 \}} p ( {β}_{k} \vert {z}^{′} ) p ( {z}^{′} \vert {β}_{1 : k - 1} )} \\ = {arg max}_{z ∈ \{ 0 , 1 , … , H - 1 \}} p ( z \vert {β}_{1 : k} )\end{matrix} . \qquad ( 6 )$$

This distribution and the most likely level can then provide a quantitative measure of how responsible a driver is compared to the collected traffic log.

Responsibility-Aware Trajectory Prediction: In the subsequent stage of the disclosed framework, example embodiments connect the discrete responsibility levels to a trajectory prediction model to generate interpretable yet precise predictions. The derived responsibility level serves as a condensed representation of the entire history of observations, which can encode longer history information than the context variable, making it a valuable input for trajectory prediction. The Boltzmann (or softmax) noisy rationality model is used in psychology and econometrics to analyze human decision-making, in which the probability of a choice is exponentially more possible as its reward increases compared to other options. Therefore, example embodiments assume that, for each responsibility level, there exists a reward function that assigns higher rewards to behaviors within that level as compared to behaviors from other levels. Example embodiments leverage these responsibility-dependent reward functions to fine-tune traffic models, as shown below.

Example embodiments start by constructing a responsibility-aware traffic dataset. For each data point (xₖ, ξ⁽ⁱ⁾) in the original dataset, example embodiments can augment it with a responsibility level zₖ-T_{f} as the responsibility metrics in (3) can be estimated from the ground truth. Additionally, example embodiments augment the data point with “artificial” trajectories from the traffic model by using the same context variable xₖ. Then, example embodiments cluster the dataset into H groups {Dₕ|h=0,1 . . . , H−1} by the learned HMM in the previous subsection.

For each group Dₕ, example embodiments train a reward function R_{ϕh}, parameterized by a neural network, to distinguish the real trajectory from the artificial trajectories through inverse reinforcement learning. Specifically, this reward function wants to minimize the binary cross-entropy loss below:

$$L ( {ϕ}_{h} ) := - {\sum }_{( ξ , y ) ∈ {D}_{h}} y log ( {R}_{ϕ h} ( ξ ) ) + ( 1 - y ) log ( 1 - {R}_{ϕ h} ( ξ ) ) ,$$

where y=1 if the trajectory is real and y=0 if the trajectory is artificial.

After the responsibility-dependent reward functions are obtained, example embodiments can re-train the traffic model by augmenting the original reconstruction loss with this additional reward function term. On the other hand, if the traffic model consists of a prediction-and-planning hierarchy, example embodiments can replace the planning cost function with the trained reward function. As further discussed below, this simple cost function replacement can vastly improve prediction accuracy without burdensome additional training.

Simulation dataset: To illustrate the improvements of embodiments of the disclosed approach, the “nuScenes” dataset (a public dataset for autonomous driving that aids study of urban driving situations), which consists of 1000 scenes in Singapore and Boston, was used. The scenes are 20s timespan each, and the map has 11 semantic layers. Example embodiments train the traffic model and HMM model on 800 scenes of the train split and evaluate 150 scenes from the validation split. For each scene, example embodiments create snapshots at 0.1s intervals. The history of 10 timesteps and the future of 20 timesteps are considered.

Traffic model: Example embodiments build on BITS architecture since it allows for generation of accurate and diverse open-loop motions (trajectories) based on goal-conditioning and planning-cost-aware selection. However, the pipeline disclosed herein is suitable for any trajectory prediction models that can predict a multimodal distribution over future trajectories, such as transformer-based methods or conditional variational autoencoders (CVAE)-based methods. Here, example embodiments focus on the vehicle-vehicle responsibility and assume all vehicles share the same unicycle dynamics. It is noted that embodiments of the disclosed framework can work with heterogeneous dynamics and are not limited to vehicle-vehicle responsibility, as different embodiments can use different dynamics per agent f⁽ⁱ⁾ as in (1). Thus, the output of the traffic model may be a sequence of linear acceleration and the heading angular velocity.

Offline ex-post traffic analysis: Embodiments of the disclosed framework can analyze drivers' responsibility and cluster their behaviors into different levels. For example, when 40 motions were sampled from the traffic model to evaluate the safety responsibility, and CVaR was computed with α=0.1. With respect to courtesy responsibility, in some embodiments the KL divergence can be approximated with the trajectories in (1).

To approximate the courtesy responsibility, some embodiments first sample possible motions (e.g., 20) of target agent [symbol] ^{(b)} from the traffic model with and without the queried agent [symbol] ^{(a)}, Ξₖ^{(b)′}(xₖ):=Ξₖ^{(b)}∪Ξₖ^{(b)}(xₖ^{-a}). Additionally, some embodiments can construct a reward function R (ξ; Ξ)=−10c_{coll}(ξ; Ξ)−c_{dev}(ξ; Ξ), which measures the collision cost and the road departure cost of target agent's trajectory ξ under its neighbor's trajectories Ξ. It is noted that this reward function can be learned from the traffic log. Some embodiments may then compute two sets of utilities:

$${𝒥}_{1} = \{ R ( ξ ; Ξ ) \vert ∀ ξ ∈ {Ξ}_{k}^{{( b )}^{′}} ( {x}_{k} ) \} ,$$

$${𝒥}_{2} = \{ R ( ξ ; {Ξ}^{- a} ) \vert ∀ ξ ∈ {Ξ}_{k}^{{( b )}^{′}} ( {x}_{k} ) \} ,$$

where Ξ^{-a} denotes trajectories of target agent's neighbor except queried agent [symbol] (a).

Some embodiments may employ the Boltzmann noisy rationality model to construct two distributions over possible trajectories Ξₖ^{(b)′}(xₖ) with two sets of utilities [symbol] ₁ and [symbol] ₂, respectively. Here, the probability that the target agent will select a trajectory is exponentially proportional to the reward of executing this trajectory, defined as ∀ξ∈Ξₖ^{(b)′}(xₖ).

$${𝒫}_{1} ( ξ ) = \frac{exp ( R ( ξ ; Ξ ) )}{{\sum }_{{ξ}^{′} ∈ {Ξ}_{k}^{{( b )}^{′}} ( {x}_{k} )} exp ( R ( {ξ}^{′} ; Ξ ) )} , \qquad ( 7 )$$

$${𝒫}_{2} ( ξ ) = \frac{exp ( R ( ξ ; {Ξ}^{- a} ) )}{{\sum }_{{ξ}^{′} ∈ {Ξ}_{k}^{{( b )}^{′}} ( {x}_{k} )} exp ( R ( {ξ}^{′} ; {Ξ}^{- a} ) )} .$$

The courtesy responsibility is approximated by βₖ^{courtesy}(a, b, xₖ)≈D_{KL}( [symbol] ₁∥ [symbol] ₂).

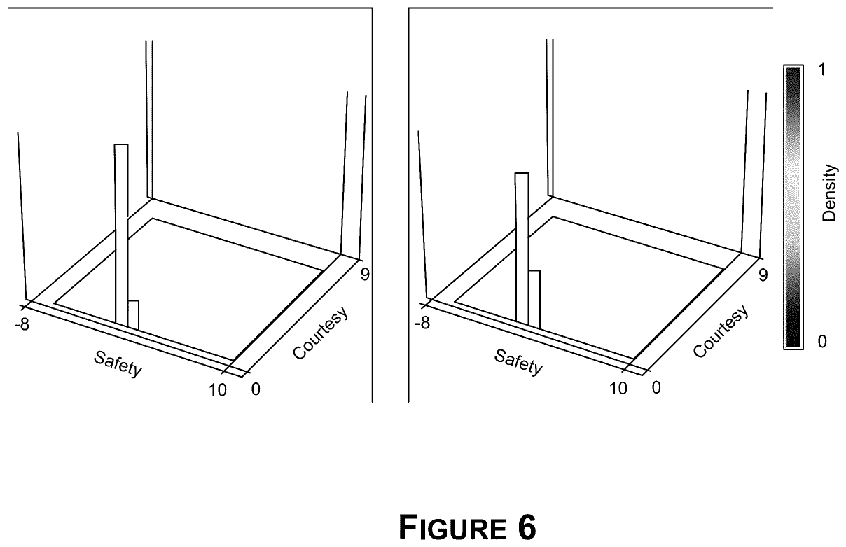

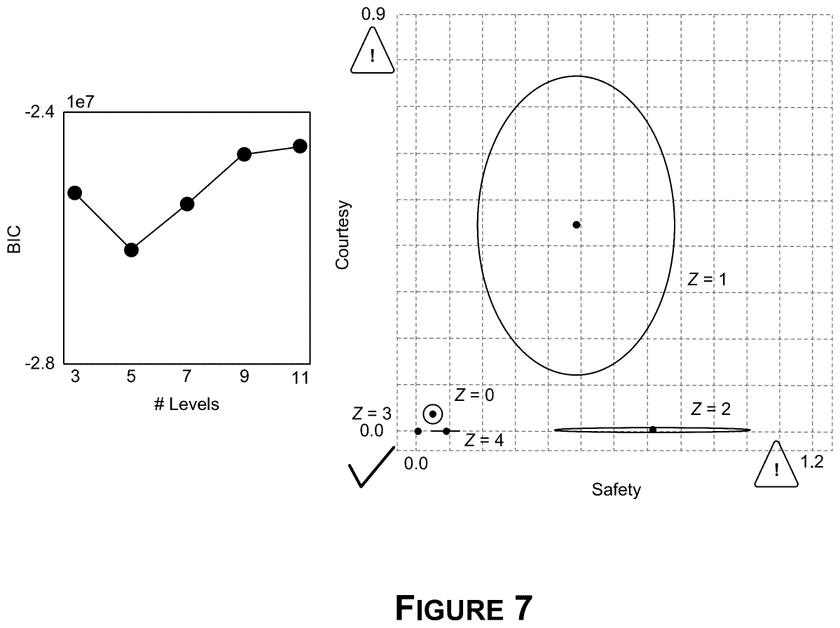

The distribution of the raw responsibility metrics is shown in FIG. 6. It is observed that most of the data fall in the region near the origin, indicating that most of the dataset's scenarios do not have interaction among agents. After obtaining responsibility observation sequences, HMMs may be trained by assuming the emission distribution is a Gaussian distribution with a diagonal covariance matrix (bₕ(⋅)= [symbol] (⋅|μₕ, Σₕ)) and implemented (e.g., with Python's PyHHMM). The different number of levels {3, 5, 7, 9, 11} can be considered, and the model that has the lowest Bayesian information criterion (BIC=2NLL+m log n) selected, where NLL is the negative log-likelihood of the observed data given the model, m is the number of the model parameters, and n is the number of the observed data. FIG. 7 shows the BIC under the different number of levels and the level-conditioned emission distributions, where the ellipses are plotted with semi-axes of half standard deviations.

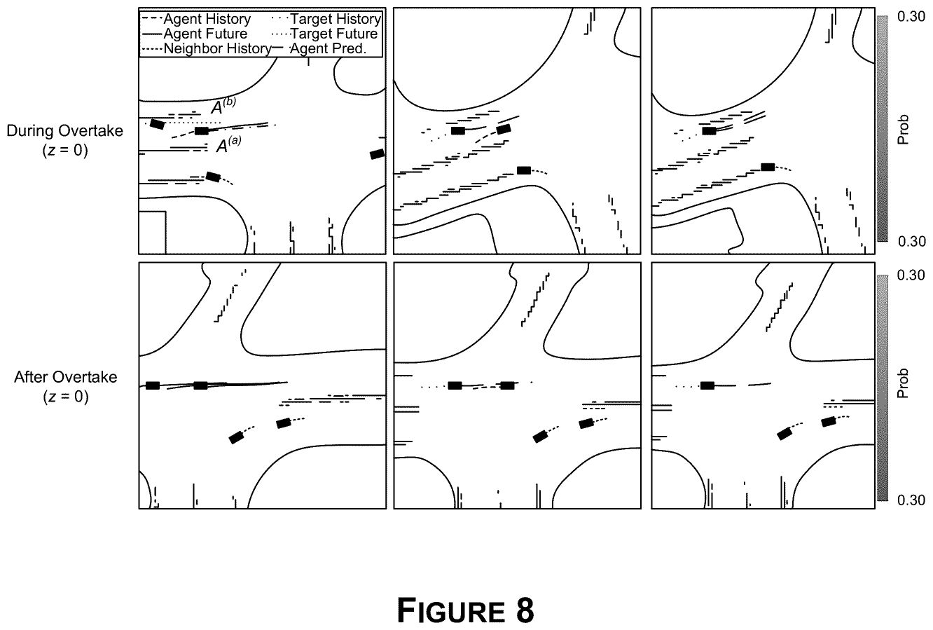

FIG. 8 provides results of an evaluation of certain embodiments of the safety and courtesy responsibility using the nuScenes dataset. The left column shows the motions the queried agent could have taken from the traffic model, as shown in the magenta trajectories. The safety value decrease can be computed for each sampled trajectory by comparing it with the queried agent's actual trajectory and the safety responsibility obtained by computing the CVaR. The center and the right columns illustrate the distributions of the target agent's motion with and without the queried agent. The courtesy responsibility can be obtained by computing the KL divergence between these two distributions. The top row shows that the first agent (“a”) could have maintained a more considerable margin toward the target agent (“b”) during the overtake. Additionally, if the first agent had been removed, the trajectory distribution of the first agent would have primarily changed. These two observations illustrate that that the first agent is irresponsible with respect to the target agent (z=1 by HMM). However, after the overtake, the first agent demonstrates more responsible behavior (z=0 by HMM).

Online responsibility-aware trajectory prediction: In various embodiments, the latent responsibility levels can be used in the framework to render interpretable but accurate trajectory predictions. Through inverse reinforcement learning, a reward function can be learned for each responsibility level that best describes the driver behaviors within this level. A certain number of motions (e.g., 24 motions) can be sampled from the traffic model and the corresponding trajectories combined with the ground-truth trajectory to form a training set. Some embodiments may retrieve four features for each trajectory, such as the collision cost (with other agents), the road deviation cost, the final displacement (progress), and the predicted probability out of the traffic model. The reward function may be parametrized with fully-connected neural networks with, for example, two layers of 32 neurons.

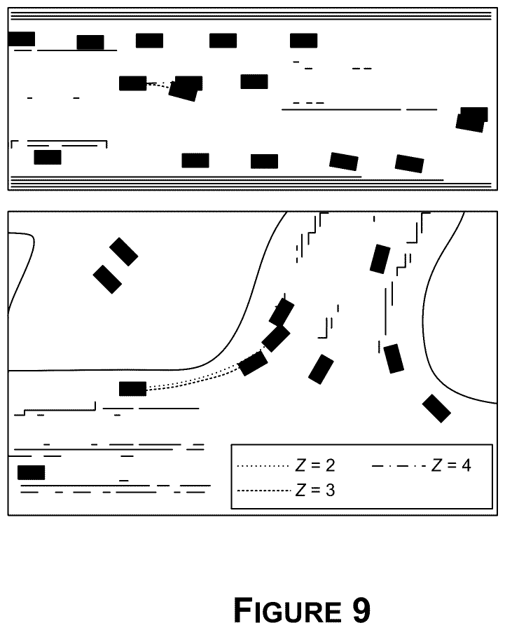

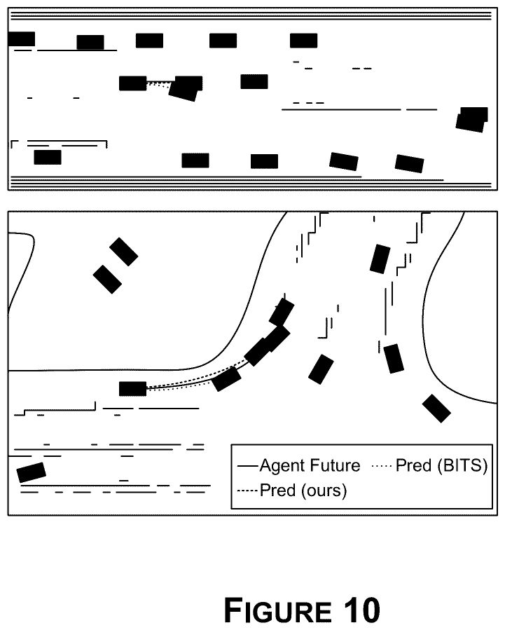

In the prediction phase, for each traffic data, some embodiments compute responsibility level h, sample a number of motions (e.g., 25 motions) from the traffic model, and select the predicted trajectory by argmax_{ξ∈Ξ}^{R}_{ϕh}(ξ). On the other hand, BITS may use the heuristic reward function introduced above and select the possible trajectory based on this reward function for all the data. FIG. 9 shows the predicted trajectories using the correct level-conditioned reward function (z=4 for the top and z=2 for the bottom) versus the most responsible level (z=3). FIG. 10 shows a responsibility-based trajectory prediction and the heuristic cost-based prediction from BITS. Table 1 shows that the disclosed embodiments outperform BITS in both average displacement error (ADE) and final displacement error (FDE) in both the training set and validation set. It is also noted that the trajectories from z=3 are close to ones from the BITS, which indicates in their implementation they construct the heuristic reward to fit most of the traffic log. However, these embodiments can distinguish responsibility levels and assign different selection criteria.

TABLE 1
Responsibility-aware selection (in accordance with the
disclosed approach) outperforms heuristic rule-based
cost in both average and final displacement error.

| | Train ADE | Train FDE | Valid ADE | Valid FDE |
|---|---|---|---|---|
| Heuristic (BITS) | 1.02 m | 0.39 m | 1.64 m | 0.65 m |
| Responsibility | 0.75 m | 0.26 m | 1.45 m | 0.57 m |

Responsibility formulation: In some embodiments, responsibility builds upon a set of open-loop motions. Agents can be assumed to make their decision based on the current state and the interaction history, so their controls do not change even after observing other agents' future states (of the predicted future horizon). Responsibility based on closed-loop policies is an extension, as this can capture an approximation of interaction, such as in the courtesy responsibility computation. In some embodiments, including the execution order of agents can result in various responsibility definitions (e.g., different order sets of leader-follower structure). It is also noted that, in alternative embodiments, responsibility concepts can be formulated in a similar pipeline, such as violation of traffic rules or respectfulness of other agents' utility.

Integration to Additional Modules in AV Software Stack: The disclosed hierarchical framework can include conducting ex-post traffic analysis and provide an interpretable lens for trajectory prediction through responsibility-dependent reward functions. In some embodiments, responsibility can be integrated into other modules in the AV software stack. For example, in some embodiments, the disclosed framework can be implemented as (or as part of) a data mining tool to cluster traffic logs into interactive and naive lane-following scenarios. In other embodiments, the disclosed framework can be included in traffic simulation, so as to imitate diverse behaviors using different responsibility-dependent reward functions for each concerned agent. Additionally, some embodiments can treat the continuous responsibility metrics or discrete levels as the attribute code and use controllable generation tools to render controls corresponding to the desired responsibility. Further, responsibility-aware policies can be helpful for the downstream planner as they can filter out unrealistic control policies or inform the importance of each scenario.

Various embodiments of the interpretability framework and the responsibility evaluations disclosed herein are applicable to a wide range of trajectory prediction methods. In some embodiments, responsibility is formulated through counterfactual reasoning, breaking up the responsibility into two components: safety responsibility, which quantifies how an agent could have reacted to allow a more significant safety margin for its surrounding agents; and courtesy responsibility, which measures how an agent's control strategy influences its neighbors' plans. In some embodiments, other metrics may be employed in place of, and/or in addition to, safety and courtesy. A hierarchical framework may be employed to abstract interactions to discrete responsibility levels and ground these low-dimensional and interpretable latent features into a learning-based trajectory prediction model. It has been experimentally shown that the responsibility metrics of various embodiments are helpful in analyzing real-world traffic logs, and that incorporating responsibility into trajectory prediction improves the accuracy of complex traffic data.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
obtain sensor data corresponding to one or more movements of a query agent proximate to an autonomous or semi-autonomous system; and
execute a trajectory prediction model to generate, based at least on the one or more movements, a trajectory for at least one of the query agent or the autonomous or semi-autonomous system, the trajectory prediction model including a responsibility formulation that is based at least on one or more counterfactual metrics.

2. The processor of claim 1, wherein the responsibility formulation is indicative of a classification for at least one of the query agent or the autonomous or semi-autonomous system.

3. The processor of claim 1, wherein the one or more counterfactual metrics includes one or more of a safety metric or a courtesy metric for the query agent.

4. The processor of claim 1, wherein the one or more counterfactual metrics includes a safety metric for the query agent with respect to at least one of the autonomous or semi-autonomous system or one or more agents other than the query agent.

5. The processor of claim 4, wherein the safety metric is indicative of one or more safety margins maintained by the query agent with respect to at least one of the autonomous or semi-autonomous system or one or more agents other than the query agent.

6. The processor of claim 1, wherein the one or more counterfactual metrics includes a courtesy metric for the query agent with respect to the autonomous or semi-autonomous system.

7. The processor of claim 6, wherein the courtesy metric is indicative of an influence, on the query agent, of at least one of the autonomous or semi-autonomous system or one or more agents other than the query agent.

8. The processor of claim 6, wherein the courtesy metric is based at least on a Kullback-Leibler (KL) divergence between at least two distributions.

9. The processor of claim 8, wherein the at least two distributions correspond to motion of the query agent (1) with the autonomous or semi-autonomous system or with one or more agents other than the query agent, and (2) without the autonomous or semi-autonomous system or without the one or more agents other than the query agent.

10. The processor of claim 1, wherein the one or more counterfactual metrics includes a safety metric and a courtesy metric for the query agent.

11. The processor of claim 1, wherein the responsibility formulation uses a reward function.

12. The processor of claim 1, the one or more circuits further to execute a maneuver by the autonomous or semi-autonomous system based at least on the generated trajectory.

13. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more language models;
a system implementing one or more large language models (LLMs);
a system for performing one or more generative AI operations;
a system for generating synthetic data;
a system for generating content for a virtual reality (VR), an augmented reality (AR), or a mixed reality (MR) system;
a system for rendering content for a virtual reality (VR), an augmented reality (AR), or a mixed reality (MR) system;
a system incorporating one or more virtual machines (VMs);
a system implemented at least partially in a data center; or
a system implemented at least partially using cloud computing resources.

14. A system comprising:
one or more processing units to perform operations comprising:
obtaining sensor data corresponding to one or more movements of a first agent proximate to a second agent; and
executing a trajectory prediction model to generate, based at least on the one or more movements, a trajectory for at least one of the first agent or the second agent, the trajectory prediction model including a responsibility formulation that is based at least on one or more counterfactual metrics.

15. The system of claim 14, wherein the one or more counterfactual metrics include a safety metric for the first agent with respect to at least one of the second agent or one or more agents other than the first agent, wherein the safety metric is indicative of one or more safety margins maintained by the first agent with respect to at least one of the second agent or one or more agents other than the first agent.

16. The system of claim 14, wherein the one or more counterfactual metrics includes a courtesy metric for the first agent with respect to the second agent, wherein the courtesy metric is indicative of an influence, on the first agent, of at least one of the second agent and/or one or more agents other than the first agent.

17. The system of claim 14, wherein the one or more counterfactual metrics includes a safety metric and a courtesy metric for the first agent.

18. The system of claim 14, wherein the system is an autonomous or semi-autonomous vehicle, wherein the vehicle comprises one or more sensors from which the sensor data or a portion thereof are received, and wherein the vehicle further comprises a control system configured to execute, based on the generated trajectory, a second trajectory for the vehicle.

19. The system of claim 14, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system implementing one or more language models;
a system implementing one or more large language models (LLMs);
a system for performing one or more generative AI operations;
a system for generating synthetic data;
a system for generating content for a virtual reality (VR), an augmented reality (AR), or a mixed reality (MR) system;
a system for rendering content for a virtual reality (VR), an augmented reality (AR), or a mixed reality (MR) system;
a system incorporating one or more virtual machines (VMs);
a system implemented at least partially in a data center; or
a system implemented at least partially using cloud computing resources.

20. A method comprising:
obtaining sensor data corresponding to one or more movements of a query agent proximate to a dynamic system; and
executing a trajectory prediction model to generate, based at least on the one or more movements, a trajectory for at least one of the query agent or the dynamic system, the trajectory prediction model comprising a responsibility formulation that is based at least on a safety metric and a courtesy metric.
